(19) United States
(12) Patent Application Publication
(10) Pub. No.: US 2018/0127593 A1
(43) Pub. Date: May 10, 2018

(54) FIBER COATINGS WITH LOW MODULUS AND HIGH CRITICAL STRESS

(71) Applicant: Corning incorporated, Corning, NY (US)

(72) Inventors: Yangbin Chen, Lima, NY (US); Ching-Kee Chien, Horseheads, NY (US); Michael Edward DeRosa, Painted Post, NY (US); Inna Igorevna Kouzmina, Corning, NY (US); Pushkar Tandon, Painted Post, NY (US); Ruchi Tandon, Painted Post, NY (US)

(21) Appl. No.: 15/794,760

(22) Filed: Oct. 26, 2017

Related U.S. Application Data
(60) Provisional application No. 62/419,154, filed on Nov. 8, 2016.

(51) Int. Cl. C09D 4/00; C08G 18/67; C08G 18/66; C08G 18/48; C08G 18/75; C08G 18/12; C03C 25/10; G02B 6/02

(52) U.S. Cl. CPC C09D 4/00; C08G 18/6725; C08G 18/6666; C08G 18/4833; C08G 2105/02; C08G 18/12; C03C 25/106; G02B 6/02395; C08G 18/758

(57) ABSTRACT

Fiber coatings with low Young's modulus, high tear strength, and/or high critical stress are realized with coating compositions that include an oligomeric material formed from an isocyanate, a hydroxy acrylate compound and a polyol. The oligomeric material includes a polyether urethane acrylate and a di-adduct compound. The reaction mixture used to form the oligomeric material includes a molar ratio of isocyanate:hydroxy acrylate:polyol of n:m:p, where when p is 2, n is in the range from 3.0 to 5.0 and m is in the range from 1.50n-3 to 2.50n-5. Control of the n:m:p ratio leads to compositions that, when cured, provide coatings and cured products having high critical stress, high tear strength, and a high ratio of tear strength to Young's modulus.

This application claims the benefit of priority under 35 U.S.C. § 119 of U.S. Provisional Application Ser. No. 62/419,154 filed on Nov. 8, 2016 the content of which is relied upon and incorporated herein by reference in its entirety.

### FIELD OF THE DISCLOSURE

This disclosure pertains to fiber coatings with low Young's modulus and high critical stress. More particularly, this disclosure pertains to oligomers for use in radiation-curable coating compositions that yield fiber coatings with low Young's modulus and high critical stress.

### BACKGROUND OF THE DISCLOSURE

The transmissivity of light through an optical fiber is highly dependent on the properties of the coatings applied to the fiber. The coatings typically include a primary coating and a secondary coating, where the secondary coating surrounds the primary coating and the primary coating contacts the glass waveguide (core+cladding) portion of the fiber. The secondary coating is a harder material (higher Young's modulus) than the primary coating and is designed to protect the glass waveguide from damage caused by abrasion or external forces that arise during processing and handling of the fiber. The primary coating is a softer material (low Young's modulus) and is designed to buffer or dissipates stresses that result from forces applied to the outer surface of the secondary coating. Dissipation of stresses within the primary layer attenuates the stress and minimizes the stress that reaches the glass waveguide. The primary coating is especially important in dissipating stresses that arise when the fiber is bent. The bending stresses transmitted to the glass waveguide on the fiber needs to be minimized because bending stresses create local perturbations in the refractive index profile of the glass waveguide. The local refractive index perturbations lead to intensity losses for the light transmitted through the waveguide. By dissipating stresses, the primary coating minimizes bend-induced intensity losses.

To minimize bending losses, it is desirable to develop primary coating materials with increasingly lower Young's moduli. Coating materials with a Young's modulus below 1 MPa are preferred. As the Young's modulus of the primary coating is reduced, however, the primary coating is more susceptible to damage in the fiber manufacturing process or during fiber installation or deployment. Thermal and mechanical stresses that arise during the fiber coating process or during post-manufacture fiber handling and configuration processes (e.g. stripping, cabling and connecting operations) may lead to the formation of defects in the primary coating. The defect formation in the primary coating becomes more problematic as the Young's modulus of the primary coating material decreases. There is a need for a primary coating material that has a low Young's modulus and yet is resistant to stress-induced defect formation during fiber manufacture and handling.

### SUMMARY

The present disclosure provides materials for use in forming coatings and cured products. The materials feature low Young's modulus, high tear strength, and high critical stress. The materials can be used as primary coatings for optical fibers. The primary coatings provide good microbending performance and are resistant to defect formation during fiber coating processing and handling operations.

The present disclosure extends to:

A composition comprising:
a diisocyanate compound;
a hydroxy (meth)acrylate compound; and
a polyol compound;
wherein said diisocyanate compound, said hydroxy (meth)acrylate compound and said polyol compound are present in the molar ratio n:m:p, respectively, where n is in the range from 3.0 to 5.0, m is in the range from 1.50n-3 to 2.50n-5, and p is 2.

In an embodiment, the composition forms a reaction product, where the reaction product comprises:

an oligomeric material, said oligomeric material comprising:
a polyether urethane acrylate compound having the molecular formula:

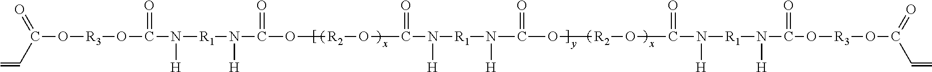

and a di-adduct compound having the molecular formula:

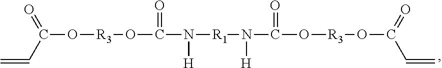

wherein
   R₁, R₂ and R₃ are independently selected from linear alkylene groups, branched alkylene groups, or cyclic alkylene groups;
   y is 1, 2, 3, or 4;
   x is between 40 and 100;
said di-adduct compound is present in an amount of at least 1.0 wt %

The present disclosure extends to:

A method of making an oligomeric material comprising:

reacting a diisocyanate compound with a hydroxy (meth)acrylate compound and a polyol compound;

wherein said diisocyanate compound, said hydroxy (meth)acrylate compound and said polyol compound are provided in the molar ratio n:m:p, respectively, where n is in the range from 3.0 to 5.0, m is in the range from 1.50n-3 to 2.50n-5, and p is 2.

The present disclosure extends to:

A fiber coating composition comprising:

one or more monomers with a radiation-curable group;

the reaction product of a composition comprising:
a diisocyanate compound;
a hydroxy (meth)acrylate compound; and
a polyol compound;
wherein said diisocyanate compound, said hydroxy (meth) acrylate compound and said polyol compound are present in the molar ratio n:m:p, respectively, where n is in the range from 3.0 to 5.0, m is in the range from 1.50n-3 to 2.50n-5, and p is 2;

and a photoinitiator.

In an embodiment, the reaction product of the fiber coating composition the reaction product comprises:

an oligomeric material, said oligomeric material comprising:
a polyether urethane acrylate compound having the molecular formula:

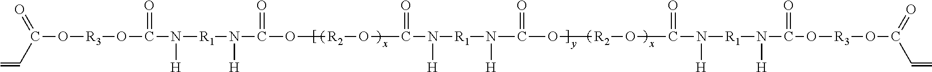

and a di-adduct compound having the molecular formula:

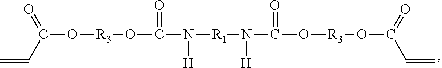

wherein
   R₁, R₂ and R₃ are independently selected from linear alkylene groups, branched alkylene groups, or cyclic alkylene groups;
   y is 1, 2, 3, or 4;
   x is between 40 and 100; and
      said di-adduct compound is present in an amount of at least 1.0 wt %.

The present disclosure extends to:

The cured product of a composition comprising:

one or more monomers with a radiation-curable group;

the reaction product of a composition comprising:
a diisocyanate compound;
a hydroxy (meth)acrylate compound; and
a polyol compound;
wherein said diisocyanate compound, said hydroxy acrylate compound and said polyol compound are present in the molar ratio n:m:p, respectively, where n is in the range from 3.0 to 5.0, m is in the range from 1.50n-3 to 2.50n-5, and p is 2; and

a photoinitiator.

In an embodiment, the reaction product of the cured product comprises:

a polyether urethane acrylate compound having the molecular formula:

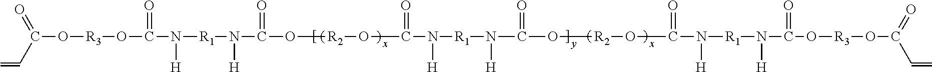

and a di-adduct compound having the molecular formula:

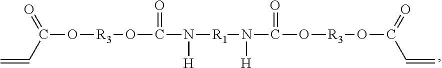

wherein
R₁, R₂ and R₃ are independently selected from linear alkyl groups, branched alkyl groups, or cyclic alkyl groups;
y is 1, 2, 3, or 4;
x is between 40 and 100; and
said di-adduct compound is present in an amount of at least 1.0 wt %.

The present description extends to:

A radiation curable optical fiber coating composition comprising:

an oligomeric material, said oligomeric material comprising a reaction product of:
a diisocyanate compound lacking aromatic groups;
a hydroxy (meth)acrylate compound; and
a polyol compound comprising polypropylene glycol with number average molecular weight between 3500 g/mol and 5500 g/mol and having unsaturation less than 0.1 meq/g; and
a mercapto-functional silane compound;
wherein said diisocyanate compound, said hydroxy (meth)acrylate compound and said polyol compound are present in the molar ratio n:m:p, respectively, and wherein 3<n<5, m is in the range from 1.50n-3 to 2.50n-5, and p is 2.

In an embodiment, the oligomeric material comprises:

a polyether urethane acrylate compound having the molecular formula:

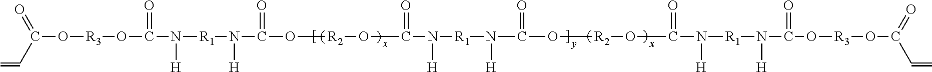

and a di-adduct compound having the molecular formula:

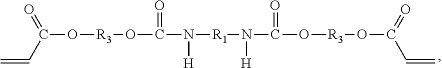

wherein
R₁, R₂ and R₃ are independently selected from linear alkylene groups, branched alkylene groups, or cyclic alkylene groups;
y is 1, 2, 3, or 4;
x is between 40 and 100;
said di-adduct compound is present in an amount between 1.0 wt % and 10 wt %

The present description extends to:

A method of coating an optical fiber comprising:

applying a coating composition to an optical fiber, said optical fiber moving at a draw speed greater than 35 m/s, said coating composition comprising:
an oligomeric material, said oligomeric material comprising a reaction product of:
   a diisocyanate compound lacking aromatic groups;
   a hydroxy (meth)acrylate compound; and
   a polyol compound comprising polypropylene glycol with number average molecular weight between 3500 g/mol and 5500 g/mol and having unsaturation less than 0.1 meq/g; and
a mercapto-functional silane compound;
wherein said diisocyanate compound, said hydroxy (meth)acrylate compound and said polyol compound are present in the molar ratio n:m:p, respectively, and wherein 3<n<5, m is in the range from 1.50n-3 to 2.50n-5, and p is 2; and

curing said coating composition with an LED source having a operating wavelength between 300 nm and 400 nm.

The present disclosure further includes fiber coatings and cured products formed from the oligomeric materials or coating compositions described herein. The fiber coating features low Young's modulus, high tear strength, high ratio of tear strength to Young's modulus, and/or high critical stress.

The present disclosure further includes an optical fiber coated with a coating formed from a composition disclosed herein, wherein the optical fiber includes a glass waveguide and the coating surrounds the glass waveguide.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present disclosure, and together with the description serve to explain principles and operation of methods, products, and compositions embraced by the present disclosure.

### BRIEF DESCRIPTION OF THE DRAWINGS

FIG. 1 illustrates the dependence of

$$\frac{{σ}_{c}}{E} on \frac{{G}_{c}}{{Er}_{0}} .$$

FIG. 2 shows 90 degree peel force of coatings made by curing coating compositions with different oligomers at various temperatures relative to 90 degree peel force at 20° C.

FIG. 3 shows fiber pullout force for coatings made by curing coating compositions with different oligomers.

FIG. 4 shows 50% damage force of coatings made by curing coating compositions with different oligomers.

### DETAILED DESCRIPTION

The present disclosure provides primary coatings that exhibit low Young's moduli and high resistance to defect formation during fiber manufacture and handling. The disclosure demonstrates that the resistance of a primary coating to defect formation correlates with the tear strength, the ratio of tear strength to Young's modulus, and/or critical stress of the coating. The present disclosure accordingly provides fiber coating compositions and components for fiber compositions that enable formation of fiber coatings that feature a low Young's modulus and high resistance to defect formation.

The present disclosure provides oligomeric materials for radiation-curable coating compositions, radiation-curable coating compositions containing at least one of the oligomeric materials, cured products of radiation-curable coating compositions that include at least one of the oligomeric materials, optical fibers coated with a radiation-curable coating composition containing at least one of the oligomeric materials, and optical fibers coated with the cured product of a radiation-curable coating composition containing at least one of the oligomeric materials.

The oligomeric material includes a polyether urethane acrylate compound and a di-adduct compound. In one embodiment, the polyether urethane acrylate compound has a linear molecular structure. In one embodiment, the oligomeric material is formed from a reaction between a diisocyanate compound, a polyol compound, and a hydroxy acrylate compound, where the reaction produces a polyether urethane acrylate compound as a primary product (majority product) and a di-adduct compound as a byproduct (minority product). The reaction forms a urethane linkage upon reaction of an isocyanate group of the diisocyanate compound and an alcohol group of the polyol. The hydroxy acrylate compound reacts to quench residual isocyanate groups that are present in the composition formed from reaction of the diisocyanate compound and polyol compound. As used herein, the term “quench” refers to conversion of isocyanate groups through a chemical reaction with hydroxyl groups of the hydroxy acrylate compound. Quenching of residual isocyanate groups with a hydroxy acrylate compound converts terminal isocyanate groups to terminal acrylate groups.

The diisocyanate compound is represented by molecular formula (I):

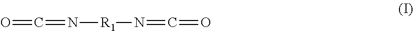

which includes two terminal isocyanate groups separated by a linkage group R₁. In one embodiment, the linkage group R₁ includes an alkylene group. The alkylene group of linkage group R₁ is linear (e.g. methylene or ethylene), branched (e.g. isopropylene), or cyclic (e.g. cyclohexylene, phenylene). The cyclic group is aromatic or non-aromatic. In some embodiments, the linkage group R₁ is 4,4′-methylene bis(cyclohexyl) group and the diisocyanate compound is 4,4′-methylene bis(cyclohexyl isocyanate). In some embodiments, the linkage group R₁ lacks an aromatic group, or lacks a phenylene group, or lacks an oxyphenylene group.

The polyol is represented by molecular formula (II):

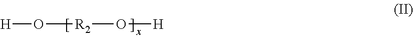

where R₂ includes an alkylene group. The alkylene group of R₂ is linear (e.g. methylene or ethylene), branched (e.g. isopropylene), or cyclic (e.g. phenylene). The polyol may be a polyalkylene oxide, such as polyethylene oxide, or a polyalkylene glycol, such as polypropylene glycol. The index x is a positive integer that represents the number of repeat units in the polyol. The index x may be at least 40, or at least 50, or at least 60, or at least 70, or at least 80, or at least 90, or at least 100, or between 40 and 100, or between 50 and 90, or between 60 and 80, or about 70. When R₂ is propylene, for example, the polyol has a number average molecular weight of about 2000 g/mol, or about 3000 g/mol, or about 4000 g/mol, or about 5000 g/mol, or in the range from 2000 g/mol-7000 g/mol, or in the range from 3000 g/mol-6000 g/mol, or in the range from 3500 g/mol-5500 g/mol. In some embodiments, the polyol is polydisperse and includes molecules spanning a range of molecular weights such that the totality of molecules combine to provide the number average molecular weight specified hereinabove.

The unsaturation of the polyol is less than 0.25 meq/g, or less than 0.15 meq/g, or less than 0.10 meq/g, or less than 0.08 meq/g, or less than 0.06 meq/g, or less than 0.04 meq/g, or less than 0.02 meq/g, or less than 0.01 meq/g, or less than 0.005 meq/g, or in the range from 0.001 meq/g-0.15 meq/g, or in the range from 0.005 meq/g-0.10 meq/g, or in the range from 0.01 meq/g-0.10 meq/g, or in the range from 0.01 meq/g-0.05 meq/g, or in the range from 0.02 meq/g-0.10 meq/g, or in the range from 0.02 meq/g-0.05 meq/g. As used herein, unsaturation refers to the value determined by the standard method reported in ASTM D4671-16. In the method, the polyol is reacted with mercuric acetate and methanol in a methanolic solution to produce acetoxymercuricmethoxy compounds and acetic acid. The reaction of the polyol with mercuric acetate is equimolar and the amount of acetic acid released is determined by titration with alcoholic potassium hydroxide to provide the measure of unsaturation used herein. To prevent interference of excess mercuric acetate on the titration of acetic acid, sodium bromide is added to convert mercuric acetate to the bromide.

The reaction further includes addition of a hydroxy acrylate compound to react with terminal isocyanate groups present in unreacted starting materials (e.g. the diisocyanate compound) or products formed in the reaction of the diisocyanate compound with the polyol (e.g. urethane compounds with terminal isocyanate groups). The hydroxy acrylate compound reacts with terminal isocyanate groups to provide terminal acrylate groups for one or more constituents of the oligomeric material. In some embodiments, the hydroxy acrylate compound is present in excess of the amount needed to fully convert terminal isocyanate groups to terminal acrylate groups. The oligomeric material includes a single polyether urethane acrylate compound or a combination of two or more polyether urethane acrylate compounds.

The hydroxy acrylate compound is represented by molecular formula (III):

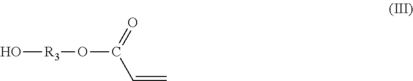

where R₃ includes an alkylene group. The alkylene group of R₃ is linear (e.g. methylene or ethylene), branched (e.g. isopropylene), or cyclic (e.g. phenylene). In some embodiments, the hydroxy acrylate compound includes substitution of the ethylenically unsaturated group of the acrylate group. Substituents of the ethylenically unsaturated group include alkyl groups. An example of a hydroxy acrylate compound with a substituted ethylenically unsaturated group is a hydroxy methacrylate compound. In different embodiments, the hydroxy acrylate compound is a hydroxyalkyl acrylate, such as 2-hydroxyethyl acrylate or a hydroxyalkyl methacrylate, such as 2-hydroxyethyl acrylate. The hydroxy acrylate compound may include water at residual or higher levels. The presence of water in the hydroxy acrylate compound may facilitate reaction of isocyanate groups to reduce the concentration of unreacted isocyanate groups in the final reaction composition. In various embodiments, the water content of the hydroxy acrylate compound is at least 300 ppm, or at least 600 ppm, or at least 1000 ppm, or at least 1500 ppm, or at least 2000 ppm, or at least 2500 ppm.

In the foregoing exemplary molecular formulas (I), III), and (III), the groups R₁, R₂, and R₃ are all the same, are all different, or include two groups that are the same and one group that is different.

The diisocyanate compound, hydroxy acrylate compound and polyol are combined simultaneously and reacted, or are combined sequentially (in any order) and reacted. In one embodiment, the oligomeric material is formed by reacting a diisocyanate compound with a hydroxy acrylate compound and reacting the resulting product composition with a polyol. In another embodiment, the oligomeric material is formed by reacting a diisocyanate compound with a polyol compound and reacting the resulting product composition with a hydroxy acrylate compound.

The oligomeric material is formed from a reaction of a diisocyanate compound, a hydroxy acrylate compound, and a polyol, where the molar ratio of the diisocyanate compound to the hydroxy acrylate compound to the polyol in the reaction process is n:m:p. n, m, and p are referred to herein as mole numbers or molar proportions of diisocyanate, hydroxy acrylate, and polyol; respectively. The mole numbers n, m and p are positive integer or positive non-integer numbers. When p is 2.0, n is in the range from 3.0-5.0, or in the range from 3.0-4.5, or in the range from 3.2-4.8, or in the range from 3.4-4.6, or in the range from 3.6-4.4, and m is in the range from 1.50n-3 to 2.50n-5, or in the range from 1.55n-3 to 2.45n-5, or in the range from 1.60n-3 to 2.40n-5, or in the range from 1.65n-3 to 2.35n-5. For example, when p is 2.0 and n is 3.0, m is in the range from 1.5 to 2.5, or in the range from 1.65 to 2.35, or in the range from 1.80 to 2.20, or in the range from 1.95 to 2.05. For values of p other than 2.0, the molar ratio n:m:p scales proportionally. For example, the molar ratio n:m:p=4.0:3.0:2.0 is equivalent to the molar ratio n:m:p=2.0:1.5:1.0.

The mole number m may be selected to provide an amount of the hydroxy acrylate compound to stoichiometrically react with unreacted isocyanate groups present in the product composition formed from the reaction of diisocyanate compound and polyol used to form the oligomeric material. The isocyanate groups may be present in unreacted diisocyanate compound (unreacted starting material) or in isocyanate-terminated urethane compounds formed in reactions of the diisocyanate compound with the polyol. Alternatively, the mole number m may be selected to provide an amount of the hydroxy acrylate compound in excess of the amount needed to stoichiometrically react with any unreacted isocyanate groups present in the product composition formed from reaction of the diisocyanate compound and the polyol. The hydroxy acrylate compound is added as a single aliquot or multiple aliquots. In one embodiment, an initial aliquot of hydroxy acrylate is included in the reaction mixture used to form the oligomeric material and the product composition formed can be tested for the presence of unreacted isocyanate groups (e.g. using FTIR spectroscopy to detect the presence of isocyanate groups). Additional aliquots of hydroxy acrylate compound may be added to the product composition to stoichiometrically react with unreacted isocyanate groups (using, for example, FTIR spectroscopy to monitor a decrease in a characteristic isocyanate frequency (e.g. at 2260 cm⁻¹-2270 cm⁻¹) as isocyanate groups are converted by the hydroxy acrylate compound). In alternate embodiments, aliquots of hydroxy acrylate compound in excess of the amount needed to stoichiometrically react with unreacted isocyanate groups are added. As described more fully below, for a given value of p, the ratio of the mole number m to the mole number n influences the relative proportions of polyether urethane acrylate compound and di-adduct compound in the oligomeric material and differences in the relative proportions of polyether urethane acrylate compound and di-adduct compound lead to differences in the tear strength and/or critical stress of coatings formed from the oligomeric material.

In one embodiment, the oligomeric material is formed from a reaction mixture that includes 4,4′-methylene bis(cyclohexyl isocyanate), 2-hydroxyethyl acrylate, and polypropylene glycol in the molar ratios n:m:p as specified above, where the polypropylene glycol has a number average molecular weight in the range from 2500 g/mol-6500 g/mol, or in the range from 3000 g/mol-6000 g/mol, or in the range from 3500 g/mol-5500 g/mol.

The oligomeric material includes two components. The first component is a polyether urethane acrylate compound having the molecular formula (IV):

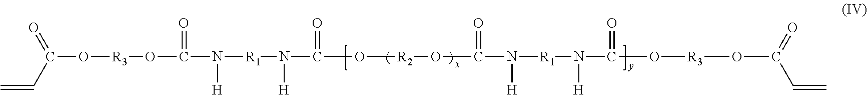

and the second component is a di-adduct compound having the molecular formula (V):

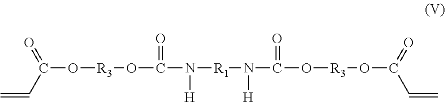

where the groups R₁, R₂, and R₃ are as described hereinabove, y is a positive integer, and it is understood that the group R₁ in molecular formulas (IV) and (V) is the same as group R₁ in molecular formula (I), the group R₂ in molecular formula (IV) is the same as group R₂ in molecular formula (II), and the group R₃ in molecular formulas (IV) and (V) is the same as group R₃ in molecular formula (III). The di-adduct compound corresponds to the compound formed by reaction of both terminal isocyanate groups of the diisocyanate compound of molecular formula (I) with the hydroxy acrylate compound of molecular formula (III) where the diisocyanate compound has undergone no reaction with the polyol of molecular formula (II).

The di-adduct compound is formed from a reaction of the diisocyanate compound with the hydroxy acrylate compound during the reaction used to form the oligomeric mixture. Alternatively, the di-adduct compound is formed independent of the reaction used to form the oligomeric mixture and is added to the product of the reaction used to form the polyether urethane acrylate compound or to a purified form of the polyether urethane acrylate compound. The hydroxy group of the hydroxy acrylate compound reacts with an isocyanate group of the diisocyanate compound to provide a terminal acrylate group. The reaction occurs at each isocyanate group of the diisocyanate compound to form the di-adduct compound. The di-adduct compound is present in the oligomeric material in an amount of at least 1.0 wt %, or at least 1.5 wt %, or at least 2.0 wt %, or at least 2.25 wt %, or at least 2.5 wt %, or at least 3.0 wt %, or at least 3.5 wt %, or at least 4.0 wt %, or at least 4.5 wt %, or at least 5.0 wt %, or at least 7.0 wt % or at least 9.0 wt %, or in the range from 1.0 wt %-10.0 wt %, or in the range from 2.0 wt % to 9.0 wt %, or in the range from 3.0 wt % to 5.58.0 wt %, or in the range from 3.5 wt % to 7.0 wt %.

An illustrative reaction for synthesizing an oligomeric material in accordance with the present disclosure includes reaction of a diisocyanate compound (4,4′-methylene bis(cyclohexyl isocyanate, which is also referred to herein as H12MDI) and a polyol (polypropylene glycol with Mₙ˜4000 g/mol, which is also referred to herein as PPG4000) to form a polyether urethane isocyanate compound:

H12MDI˜PPG4000˜H12MDI˜PPG4000˜H12MDI

where “˜” denotes a urethane linkage formed by the reaction of a terminal isocyanate group of H12MDI with a terminal alcohol group of PPG4000 and ˜H12MDI, ˜H12MDI˜, and ˜PPG4000˜ refer to residues of H12MDI and PPG4000 remaining after the reaction. The polyether urethane isocyanate compound has a repeat unit of the type ˜(H12MDI˜PPG4000)˜. The particular polyether urethane isocyanate shown includes two PPG4000 units. The reaction may also provide products having one PPG4000 unit, or three or more PPG4000 units. The polyether urethane isocyanate and any unreacted H12MDI include terminal isocyanate groups. In accordance with the present disclosure, a hydroxy acrylate compound (such as 2-hydroxyethyl acrylate, which is referred to herein as HEA) is included in the reaction to react with terminal isocyanate groups to convert them to terminal acrylate groups. The conversion of terminal isocyanate groups to terminal acrylate groups effects a quenching of the isocyanate group. The amount of HEA included in the reaction may be an amount estimated to react stoichiometrically with the expected concentration of unreacted isocyanate groups or an amount in excess of the expected stoichiometric amount. Reaction of HEA with the polyether urethane isocyanate compound forms the polyether urethane acrylate compound

HEA˜H12MDI˜PPG4000˜H12MDI˜PPG4000˜H12MDI

and/or the polyether urethane acrylate compound

HEA˜H12MDI˜PPG4000˜H12MDI˜PPG4000˜H12MDI˜HEA

and reaction of HEA with unreacted H12MDI forms the di-adduct compound:

HEA˜H12MDI˜HEA

where, as above, ˜ designates a urethane linkage and ˜HEA designates the residue of HEA remaining after reaction to form the urethane linkage. The combination of a polyether urethane acrylate compound and a di-adduct compound in the product composition constitutes an oligomeric material in accordance with the present disclosure. As described more fully hereinbelow, when one or more oligomeric materials are used in coating compositions, coatings having improved tear strength and critical stress characteristics result. In particular, it is demonstrated that oligomeric materials having a high proportion of di-adduct compound provide coatings with high tear strengths and/or high critical stress values.

Although depicted for the illustrative combination of H12MDI, HEA and PPG4000, the foregoing reaction may be generalized to an arbitrary combination of a diisocyanate compound, a hydroxy acrylate compound, and a polyol, where the hydroxy acrylate compound reacts with terminal isocyanate groups to form terminal acrylate groups and where urethane linkages form from reactions of isocyanate groups and alcohol groups of the polyol or hydroxy acrylate compound.

The oligomeric material includes a first component that is a polyether urethane acrylate compound of the type:

(hydroxy acrylate)˜(diisocyanate˜polyol)ₓ˜diisocyanate˜(hydroxy acrylate)

and a second component that is a di-adduct compound of the type:

(hydroxy acrylate)˜diisocyanate˜(hydroxy acrylate)

where the relative proportions of diisocyanate compound, hydroxy acrylate compound, and polyol used in the reaction to form the oligomeric material correspond to the mole numbers n, m, and p disclosed hereinabove.

Compounds represented by molecular formulas (I) and (II) above, for example, react to form a polyether urethane isocyanate compound represented by molecular formula (VI):

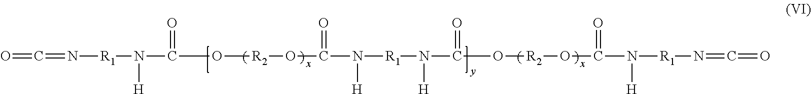

where y is the same as y in formula (IV) and is 1, or 2, or 3 or 4 or higher; and x is determined by the number of repeat units of the polyol (as described hereinabove).

Further reaction of the polyether urethane isocyanate of molecular formula (VI) with the hydroxy acrylate of molecular formula (III) provides the polyether urethane acrylate compound represented by molecular formula (IV) referred to hereinabove and repeated below:

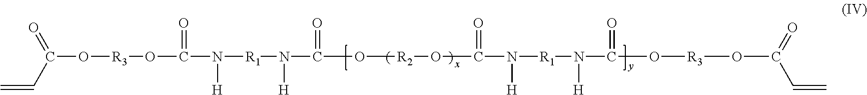

where y is 1, or 2, or 3, or 4 or higher; and x is determined by the number of repeat units of the polyol (as described hereinabove).

In an embodiment, the reaction between the diisocyanate compound, hydroxy acrylate compound, and polyol yields a series of polyether urethane acrylate compounds that differ in y such that the average value of y over the distribution of compounds present in the final reaction mixture is a non-integer. In an embodiment, the average value of y in the polyether urethane isocyanates and polyether urethane acrylates of molecular formulas (VI) and (IV) corresponds to p or p−1 (where p is as defined hereinabove). In an embodiment, the average number of occurrences of the group R₁ in the polyether urethane isocyanates and polyether urethane acrylates of the molecular formulas (VI) and (IV) correspond to n (where n is as defined hereinabove).

The relative proportions of the polyether urethane acrylate and di-adduct compounds produced in the reaction are controlled by varying the molar ratio of the mole numbers n, m, and p. By way of illustration, the case where p=2.0 is considered. In the theoretical limit of complete reaction, two equivalents p of polyol would react with three equivalents n of a diisocyanate to form a compound having molecular formula (VI) in which y=2. The compound includes two terminal isocyanate groups, which can be quenched with subsequent addition of two equivalents m of a hydroxy acrylate compound in the theoretical limit to form the corresponding polyether urethane acrylate compound (IV) with y=2. A theoretical molar ratio n:m:p=3.0:2.0:2.0 is defined for this situation.

In the foregoing exemplary theoretical limit, a reaction of diisocyanate, hydroxy acrylate, and polyol in the theoretical molar ratio n:m:p=3.0:2.0:2.0 provides a polyether urethane acrylate compound having molecular formula (IV) in which y=2 without forming a di-adduct compound. Variations in the mole numbers n, m, and p provide control over the relative proportions of polyether urethane acrylate and di-adduct formed in the reaction. Increasing the mole number n relative to the mole number m or the mole number p, for example, may increase the amount of di-adduct compound formed in the reaction. Reaction of the diisocyanate compound, the hydroxy acrylate compound, and polyol compound in molar ratios n:m:p, where n>3.0, such as where n is between 3.0 and 4.5, m is between 1.5n-3 and 2.5n-5, and p is 2.0, for example, produce amounts of the di-adduct compound in the oligomeric material sufficient to achieve the beneficial coating properties described hereinbelow.

Variations in the relative proportions of di-adduct and polyether urethane acrylate are obtained through changes in the mole numbers n, m, and p and through such variations, it is possible to precisely control the tear strength, critical stress, and other mechanical properties of coatings formed from coating compositions that include the oligomeric material. Coarse or discrete control over properties is achievable in prior art formulations by varying the number of units of polyol in the polyether urethane acrylate compound (e.g. p=2.0 vs. p=3.0 vs. p=4.0). The methods of the present disclosure, in contrast, permit fine or more nearly continuous control of tear strength, critical stress, and other mechanical properties in coatings formed from oligomeric materials that include a polyether urethane acrylate compound with a fixed number of polyol units (e.g. p=2.0) and variable amounts of di-adduct compound. For a polyether urethane compound with a given number of polyol units, oligomeric materials having variable proportions of di-adduct compound can be prepared. The variability in proportion of di-adduct compound can be finely controlled to provide oligomeric materials based on a polyether urethane compound with a fixed number of polyol units that provide coatings that offer precise or targeted values of tear strength, critical stress, or other mechanical properties.

Improved fiber coatings result when utilizing a coating composition that incorporates an oligomeric material that includes a polyether urethane acrylate compound represented by molecular formula (IV) and a di-adduct compound represented by molecular formula (V), where concentration of the di-adduct compound in the oligomeric material is at least 1.0 wt %, or at least 1.5 wt %, or at least 2.0 wt %, or at least 2.5 wt %, or at least 3.0 wt %, or at least 3.5 wt %, or at least 4.0 wt %, or at least 4.5 wt %, or at least 5.0 wt %, or at least 7.0 wt % or at least 9.0 wt %, or in the range from 1.0 wt %-10.0 wt %, or in the range from 2.0 wt % to 9.0 wt %, or in the range from 3.0 wt % to 8.0 wt %, or in the range from 3.5 wt % to 7.0 wt % or in the range from 2.5 wt % to 6.0 wt %, or in the range from 3.0 wt % to 5.5 wt %, or in the range from 3.5 wt % to 5.0 wt %. The concentration of the di-adduct compound may be increased by varying the molar ratio n:m:p of diisocyanate:hydroxy acrylate:polyol. In accordance with the present disclosure, molar ratios n:m:p that are rich in diisocyanate relative to polyol promote the formation of the di-adduct compound.

In the exemplary stoichiometric ratio n:m:p=3:2:2 described hereinabove, the reaction proceeds with p equivalents of polyol, n=p+1 equivalents of diisocyanate, and two equivalents of hydroxy acrylate. If the mole number n exceeds p+1, the diisocyanate compound is present in excess relative to the amount of polyol compound needed to form the polyether urethane acrylate of molecular formula (IV). The presence of excess diisocyanate shifts the distribution of reaction products toward enhanced formation of the di-adduct compound.

To promote formation of the di-adduct compound from excess diisocyanate compound, the amount of hydroxy acrylate can also be increased. For each equivalent of diisocyanate above the stoichiometric mole number n=p+1, two equivalents of hydroxy acrylate are needed to form the di-adduct compound. In the case of arbitrary mole number p (polyol), the stoichiometric mole numbers n (diisocyanate) and m (hydroxy acrylate) are p+1 and 2, respectively. As the mole number n is increased above the stoichiometric value, the equivalents of hydroxy acrylate needed for complete reaction of excess diisocyanate to form the di-adduct compound may be expressed as m=2+2[n−(p+1)], where the leading term “2” represents the equivalents of hydroxy acrylate needed to terminate the polyether urethane acrylate compound (compound having molecular formula (V)) and the term 2[n−(p+1)] represents the equivalents of hydroxy acrylate needed to convert the excess starting diisocyanate to the di-adduct compound. If the actual value of the mole number m is less than this number of equivalents, the available hydroxy acrylate reacts with isocyanate groups present on the oligomer or free diisocyanate molecules to form terminal acrylate groups. The relative kinetics of the two reaction pathways dictates the relative amounts of polyether urethane acrylate and di-adduct compounds formed and the deficit in hydroxy acrylate relative to the amount required to quench all unreacted isocyanate groups may be controlled to further influence the relative proportions of polyether urethane acrylate and di-adduct formed in the reaction.

In some embodiments, the reaction includes heating the reaction composition formed from the diisocyanate compound, hydroxy acrylate compound, and polyol. The heating facilitates conversion of terminal isocyanate groups to terminal acrylate groups through a reaction of the hydroxy acrylate compound with terminal isocyanate groups. In different embodiments, the hydroxy acrylate compound is present in excess in the initial reaction mixture and/or is otherwise available or added in unreacted form to effect conversion of terminal isocyanate groups to terminal acrylate groups. The heating occurs at a temperature above 40° C. for at least 12 hours, or at a temperature above 40° C. for at least 18 hours, or at a temperature above 40° C. for at least 24 hours, or at a temperature above 50° C. for at least 12 hours, or at a temperature above 50° C. for at least 18 hours, or at a temperature above 50° C. for at least 24 hours, or at a temperature above 60° C. for at least 12 hours, or at a temperature above 60° C. for at least 18 hours, or at a temperature above 60° C. for at least 24 hours.

In an embodiment, conversion of terminal isocyanate groups on the polyether urethane acrylate compound or starting diisocyanate compound (unreacted initial amount or amount present in excess) to terminal acrylate groups is facilitated by the addition of a supplemental amount of hydroxy acrylate compound to the reaction mixture. As indicated hereinabove, the amount of hydroxy acrylate compound needed to quench (neutralize) terminal isocyanate groups may deviate from the theoretical number of equivalents due, for example, to incomplete reaction or a desire to control the relative proportions of polyether urethane acrylate compound and di-adduct compound. As described hereinabove, once the reaction has proceeded to completion or other endpoint, it is preferable to quench (neutralize) residual isocyanate groups to provide a stabilized reaction product. In an embodiment, supplemental hydroxy acrylate is added to accomplish this objective.

In an embodiment, the amount of supplemental hydroxy acrylate compound is in addition to the amount included in the initial reaction process. The presence of terminal isocyanate groups at any stage of the reaction is monitored, for example, by FTIR spectroscopy (e.g. using a characteristic isocyanate stretching mode near 2265 cm⁻¹) and supplemental hydroxy acrylate compound is added as needed until the intensity of the characteristic stretching mode of isocyanate groups is negligible or below a pre-determined threshold. In an embodiment, supplemental hydroxy acrylate compound is added beyond the amount needed to fully convert terminal isocyanate groups to terminal acrylate groups. In different embodiments, supplemental hydroxy acrylate compound is included in the initial reaction mixture (as an amount above the theoretical amount expected from the molar amounts of diisocyanate and polyol), added as the reaction progresses, and/or added after reaction of the diisocyanate and polyol compounds has occurred to completion or pre-determined extent.

Amounts of hydroxy acrylate compound above the amount needed to fully convert isocyanate groups are referred to herein as excess amounts of hydroxy acrylate compound. When added, the excess amount of hydroxy acrylate compound is at least 20% of the amount of supplemental hydroxy acrylate compound needed to fully convert terminal isocyanate groups to terminal acrylate groups, or at least 40% of the amount of supplemental hydroxy acrylate compound needed to fully convert terminal isocyanate groups to terminal acrylate groups, or at least 60% of the amount of supplemental hydroxy acrylate compound needed to fully convert terminal isocyanate groups to terminal acrylate groups, or at least 90% of the amount of supplemental hydroxy acrylate compound needed to fully convert terminal isocyanate groups to terminal acrylate groups.

In an embodiment, the amount of supplemental hydroxy acrylate compound may be sufficient to completely or nearly completely quench residual isocyanate groups present in the oligomeric material formed in the reaction. Quenching of isocyanate groups is desirable because isocyanate groups are relatively unstable and often undergo reaction over time. Such reaction alters the characteristics of the reaction composition or oligomeric material and may lead to inconsistencies in coatings formed therefrom. Reaction compositions and products formed from the starting diisocyanate and polyol compounds that are free of residual isocyanate groups are expected to have greater stability and predictability of characteristics.

In an embodiment, the oligomeric material of the present disclosure is included in a coating composition from which a coating may be prepared. The coating may be a primary coating. The coating composition may be curable. In addition to the oligomeric material, the coating composition may include monomers, a polymerization initiator, and one or more additives.

Curable coating compositions include one or more curable components. As used herein, the term “curable” is intended to mean that the component, when exposed to a suitable source of curing energy, includes one or more curable functional groups capable of forming covalent bonds that participate in linking (bonding) the component to itself or to other components to form a polymeric coating material. The product obtained by curing a curable coating composition is referred to herein as a coating or as the cured product of the composition. The curing process is induced by any of several forms of energy. Forms of energy include radiation or thermal energy. A radiation-curable component is a component that is induced to undergo a curing reaction when exposed to radiation of a suitable wavelength at a suitable intensity for a sufficient period of time. The radiation curing reaction preferably occurs in the presence of a photoinitiator. A radiation-curable component is optionally also thermally curable. Similarly, a thermally-curable component is a component that is induced to undergo a curing reaction when exposed to thermal energy of sufficient intensity for a sufficient period of time. A thermally curable component is optionally also radiation curable. Curable components include monomers, oligomers, and polymers.

A curable component may include one or more curable functional groups. A curable component with only one curable functional group may be referred to herein as a monofunctional curable component. A curable component having two or more curable functional groups is referred to herein as a multifunctional curable component or a polyfunctional curable component. Multifunctional curable components include two or more functional groups capable of forming covalent bonds during the curing process and can introduce crosslinks into the polymeric network formed during the curing process. Multifunctional curable components are also referred to herein as “crosslinkers” or “curable crosslinkers”. Examples of functional groups that participate in covalent bond formation during the curing process are identified below.

In an embodiment, the oligomeric component of the coating composition is or includes an oligomeric material in accordance with the present disclosure, where the oligomeric material includes a polyether urethane acrylate compound and di-adduct compound as described hereinabove, and where the di-adduct compound is present in the oligomeric material in amounts as described hereinabove. The oligomeric component may optionally include one or more oligomer compounds in addition to the oligomeric material of the present disclosure. In embodiments, the additional oligomer compound includes a urethane acrylate oligomer, or a urethane acrylate oligomer that includes one or more aliphatic urethane groups, or a urethane acrylate oligomer that includes a single urethane group, or a urethane acrylate oligomer that includes a single aliphatic urethane group. In an embodiment, the urethane group is formed from a reaction between an isocyanate group and an alcohol group.

In an embodiment, the additional oligomer compound includes an acrylate-terminated oligomer. Illustrative acrylate-terminated oligomers include BR3731, BR3741, BR582 and KWS4131, (available from Dymax Oligomers & Coatings); polyether urethane acrylate oligomers (e.g., CN986, available from Sartomer Company); polyester urethane acrylate oligomers (e.g., CN966 and CN973, available from Sartomer Company, and BR7432, available from Dymax Oligomers & Coatings); polyether acrylate oligomers (e.g., GENOMER 3456, available from Rahn AG); and polyester acrylate oligomers (e.g., EBECRYL 80, 584 and 657, available from Cytec Industries Inc.). Other oligomers are described in U.S. Pat. Nos. 4,609,718; 4,629,287; and 4,798,852, the disclosures of which are hereby incorporated by reference in their entirety herein.

In an embodiment, the additional oligomer compound includes a soft block with a number average molecular weight (Mₙ) of about 4000 g/mol or greater. Examples of such oligomers are described in U.S. Published Patent Application No. 20030123839, the disclosure of which is incorporated by reference herein in its entirety. These oligomers have flexible backbones, low polydispersities, and/or provide cured coatings of low crosslink densities.

The total oligomer content of the coating composition is between about 5 wt % and about 95 wt %, or between about 25 wt % and about 65 wt %, or between about 35 wt % and about 55 wt %. The entirety of the oligomeric component of the coating composition preferably includes an oligomeric material in accordance with the present disclosure. The oligomeric component of the coating composition may optionally include one or more oligomers in addition to an oligomeric material in accordance with the present disclosure.

The monomer component of the coating composition is selected to be compatible with the oligomer, to provide a low viscosity formulation, and/or to influence the physical or chemical properties of the coating. In an embodiment, the monomer is selected to provide curable compositions having decreased gel times and/or cured products having low Young's moduli. The coating composition includes a single monomer or a combination of monomers. The monomers include ethylenically-unsaturated compounds, ethoxylated acrylates, ethoxylated alkylphenol monoacrylates, propylene oxide acrylates, n-propylene oxide acrylates, isopropylene oxide acrylates, monofunctional acrylates, monofunctional aliphatic epoxy acrylates, multifunctional acrylates, multifunctional aliphatic epoxy acrylates, and combinations thereof.

In embodiments, the monomer component of the coating composition includes compounds having the general formula R₂—R₁—O—(CH₂CH₃CH—O)_{q}—COCH═CH₂, where R₁ and R₂ are aliphatic, aromatic, or a mixture of both, and q=1 to 10, or R₁—O—(CH₂CH₃CH—O)_{q}—COCH═CH₂, where R₁ is aliphatic or aromatic, and q=1 to 10. Representative examples include ethylenically unsaturated monomers such as lauryl acrylate (e.g., SR335 available from Sartomer Company, Inc., AGEFLEX FA12 available from BASF, and PHOTOMER 4812 available from IGM Resins), ethoxylated nonylphenol acrylate (e.g., SR504 available from Sartomer Company, Inc. and PHOTOMER 4066 available from IGM Resins), caprolactone acrylate (e.g., SR495 available from Sartomer Company, Inc., and TONE M-100 available from Dow Chemical), phenoxyethyl acrylate (e.g., SR339 available from Sartomer Company, Inc., AGEFLEX PEA available from BASF, and PHOTOMER 4035 available from IGM Resins), isooctyl acrylate (e.g., SR440 available from Sartomer Company, Inc. and AGEFLEX FA8 available from BASF), tridecyl acrylate (e.g., SR489 available from Sartomer Company, Inc.), isobornyl acrylate (e.g., SR506 available from Sartomer Company, Inc. and AGEFLEX IBOA available from CPS Chemical Co.), tetrahydrofurfuryl acrylate (e.g., SR285 available from Sartomer Company, Inc.), stearyl acrylate (e.g., SR257 available from Sartomer Company, Inc.), isodecyl acrylate (e.g., SR395 available from Sartomer Company, Inc. and AGEFLEX FA10 available from BASF), 2-(2-ethoxyethoxy)ethyl acrylate (e.g., SR256 available from Sartomer Company, Inc.), epoxy acrylate (e.g., CN120, available from Sartomer Company, and EBECRYL 3201 and 3604, available from Cytec Industries Inc.), lauryloxyglycidyl acrylate (e.g., CN130 available from Sartomer Company) and phenoxyglycidyl acrylate (e.g., CN131 available from Sartomer Company) and combinations thereof.

In some embodiments, the monomer component of the coating composition includes a multifunctional (meth)acrylate. As used herein, the term “(meth)acrylate” means acrylate or methacrylate. Multifunctional (meth)acrylates are (meth)acrylates having two or more polymerizable (meth)acrylate moieties per molecule, or three or more polymerizable (meth)acrylate moieties per molecule. Examples of multifunctional (meth)acrylates include dipentaerythritol monohydroxy pentaacrylate (e.g., PHOTOMER 4399 available from IGM Resins); methylolpropane polyacrylates with and without alkoxylation such as trimethylolpropane triacrylate, ditrimethylolpropane tetraacrylate (e.g., PHOTOMER 4355, IGM Resins); alkoxylated glyceryl triacrylates such as propoxylated glyceryl triacrylate with propoxylation being 3 or greater (e.g., PHOTOMER 4096, IGM Resins); and erythritol polyacrylates with and without alkoxylation, such as pentaerythritol tetraacrylate (e.g., SR295, available from Sartomer Company, Inc. (Westchester, Pa.)), ethoxylated pentaerythritol tetraacrylate (e.g., SR494, Sartomer Company, Inc.), dipentaerythritol pentaacrylate (e.g., PHOTOMER 4399, IGM Resins, and SR399, Sartomer Company, Inc.), tripropyleneglycol di(meth)acrylate, propoxylated hexanediol di(meth)acrylate, tetrapropyleneglycol di(meth)acrylate, pentapropyleneglycol di(meth)acrylate. In an embodiment, a multifunctional (meth)acrylate is present in the primary curable composition at a concentration of from 0.05-15 wt %, or from 0.1-10 wt %.

In an embodiment, the monomer component of the coating compositions includes an N-vinyl amide such as an N-vinyl lactam, or N-vinyl pyrrolidinone, or N-vinyl caprolactam, where the N-vinyl amide monomer is present at a concentration from 0.1-40 wt %, or from 2-10 wt %.

In an embodiment, the coating composition includes one or more monofunctional (meth)acrylate monomers in an amount from 5-95 wt %, or from 30-75 wt %, or from 40-65 wt %. In another embodiment, the coating composition may include one or more monofunctional aliphatic epoxy acrylate monomers in an amount from 5-40 wt %, or from 10-30 wt %.

In an embodiment, the monomer component of the coating composition includes a hydroxyfunctional monomer. A hydroxyfunctional monomer is a monomer that has a pendant hydroxy moiety in addition to other reactive functionality such as (meth)acrylate. Examples of hydroxyfunctional monomers including pendant hydroxyl groups include caprolactone acrylate (available from Dow Chemical as TONE M-100); poly(alkylene glycol) mono(meth)acrylates, such as poly(ethylene glycol) monoacrylate, poly(propylene glycol) monoacrylate, and poly(tetramethylene glycol) monoacrylate (each available from Monomer, Polymer & Dajac Labs); 2-hydroxyethyl (meth)acrylate, 3-hydroxypropyl (meth)acrylate, and 4-hydroxybutyl (meth)acrylate (each available from Aldrich).

In an embodiment, the hydroxyfunctional monomer is present in an amount sufficient to improve adhesion of the coating to the optical fiber. The hydroxyfunctional monomer is present in the coating composition in an amount between about 0.1 wt % and about 25 wt %, or in an amount between about 5 wt % and about 8 wt %. The use of the hydroxyfunctional monomer may decrease the amount of adhesion promoter necessary for adequate adhesion of the primary coating to the optical fiber. The use of the hydroxyfunctional monomer may also tend to increase the hydrophilicity of the coating. Hydroxyfunctional monomers are described in more detail in U.S. Pat. No. 6,563,996, the disclosure of which is hereby incorporated by reference in its entirety.

In different embodiments, the total monomer content of the coating composition is between about 5 wt % and about 95 wt %, or between about 30 wt % and about 75 wt %, or between about 40 wt % and about 65 wt %.

In some embodiments, the coating composition includes an N-vinyl amide monomer at a concentration of 0.1 to 40 wt % or 2 to 10 wt % in combination with an oligomeric material in accordance with the present disclosure in an amount from 5 to 95 wt %, or from 25 to 65 wt % or from 35 to 55 wt %.

In some embodiments, the coating composition includes one or more monofunctional (meth)acrylate monomers in an amount of from about 5 to 95 wt %; an N-vinyl amide monomer in an amount of from about 0.1 to 40 wt %; and an oligomeric material in accordance with the present disclosure in an amount of from about 5 to 95 wt %.

In some embodiments, the coating composition may include one or more monofunctional (meth)acrylate monomers in an amount of from about 40 to 65% by weight; an N-vinyl amide monomer in an amount of from about 2 to 10% by weight; and an oligomeric material in accordance with the present disclosure in an amount of from about 35 to 60% by weight.

In some embodiments, the coating composition may also include one or more polymerization initiators and one or more additives.

The polymerization initiator facilitates initiation of the polymerization process associated with the curing of the coating composition to form the coating. Polymerization initiators include thermal initiators, chemical initiators, electron beam initiators, and photoinitiators. Photoinitiators include ketonic photoinitiating additives and/or phosphine oxide additives. When used in the photoformation of the coating of the present disclosure, the photoinitiator is present in an amount sufficient to enable rapid radiation curing. The wavelength of curing radiation is infrared, visible, or ultraviolet.

Representative photoinitiators include 1-hydroxycyclohexylphenyl ketone (e.g., IRGACURE 184 available from BASF)); bis(2,6-dimethoxybenzoyl)-2,4,4-trimethylpentylphosphine oxide (e.g., commercial blends IRGACURE 1800, 1850, and 1700 available from BASF); 2,2-dimethoxy-2-phenylacetophenone (e.g., IRGACURE 651, available from BASF); bis(2,4,6-trimethylbenzoyl)-phenylphosphine oxide (IRGACURE 819); (2,4,6-trimethylbenzoyl)diphenyl phosphine oxide (LUCIRIN TPO, available from BASF (Munich, Germany)); ethoxy(2,4,6-trimethylbenzoyl)-phenylphosphine oxide (LUCIRIN TPO-L from BASF); and combinations thereof.

The coating composition includes a single photoinitiator or a combination of two or more photoinitiators. The total photoinitiator content of the coating composition is up to about 10 wt %, or between about 0.5 wt % and about 6 wt %.

In addition to monomer(s), oligomer(s) and/or oligomeric material(s), and polymerization initiator(s), the coating composition optionally includes one or more additives. Additives include an adhesion promoter, a strength additive, an antioxidant, a catalyst, a stabilizer, an optical brightener, a property-enhancing additive, an amine synergist, a wax, a lubricant, and/or a slip agent. Some additives operate to control the polymerization process, thereby affecting the physical properties (e.g., modulus, glass transition temperature) of the polymerization product formed from the coating composition. Other additives affect the integrity of the cured product of the coating composition (e.g., protect against de-polymerization or oxidative degradation).

An adhesion promoter is a compound that facilitates adhesion of the primary coating and/or primary composition to glass (e.g. the cladding portion of a glass fiber). Suitable adhesion promoters include alkoxysilanes, mercapto-functional silanes, organotitanates, and zirconates. Representative adhesion promoters include mercaptoalkyl silanes or mercaptoalkoxy silanes such as 3-mercaptopropyl-trialkoxysilane (e.g., 3-mercaptopropyl-trimethoxysilane, available from Gelest (Tullytown, Pa.)); bis(trialkoxysilyl-ethyl)benzene; acryloxypropyltrialkoxysilane (e.g., (3-acryloxypropyl)-trimethoxysilane, available from Gelest), methacryloxypropyltrialkoxysilane, vinyltrialkoxysilane, bis(trialkoxysilylethyl)hexane, allyltrialkoxysilane, styrylethyltrialkoxysilane, and bis(trimethoxysilylethyl)benzene (available from United Chemical Technologies (Bristol, Pa.)); see U.S. Pat. No. 6,316,516, the disclosure of which is hereby incorporated by reference in its entirety herein.

The adhesion promoter is present in the coating composition in an amount between 0.02 wt % and 10.0 wt %, or between 0.05 wt % and 4.0 wt %, or between 0.1 wt % and 4.0 wt %, or between 0.1 wt % and 3.0 wt %, or between 0.1 wt % and 2.0 wt %, or between 0.1 wt % and 1.0 wt %, or between 0.5 wt % and 4.0 wt %, or between 0.5 wt % and 3.0 wt %, or between 0.5 wt % and 2.0 wt %, or between 0.5 wt % to 1.0 wt %.

Representative strength additives include mercapto-functional compounds, such as N-(tert-butoxycarbonyl)-L-cysteine methyl ester, pentaerythritol tetrakis(3-mercaptopropionate), (3-mercaptopropyl)-trimethoxysilane; (3-mercaptopropyl)trimethoxy-silane, and dodecyl mercaptan. The strength additive may be present in the coating composition in an amount less than about 1 wt %, or in an amount less than about 0.5 wt %, or in an amount between about 0.01 wt % and about 0.1 wt %.

A representative antioxidant is thiodiethylene bis[3-(3,5-di-tert-butyl)-4-hydroxy-phenyl) propionate] (e.g., IRGANOX 1035, available from BASF).

Representative optical brighteners include TINOPAL OB (available from BASF); Blankophor KLA (available from Bayer); bisbenzoxazole compounds; phenylcoumarin compounds; and bis(styryl)biphenyl compounds. In an embodiment, the optical brightener is present in the coating composition at a concentration of 0.005 wt %-0.3 wt %.

Representative amine synergists include triethanolamine; 1,4-diazabicyclo[2.2.2]octane (DABCO), triethylamine, and methyldiethanolamine. In an embodiment, an amine synergist is present at a concentration of 0.02 wt %-0.5 wt %.

Curing of the coating composition provides a cured product or coating with increased resistance to defect formation during manufacturing or subsequent processing or handling. As described in greater detail hereinbelow, the present disclosure demonstrates that coatings having high tear strength and/or high critical stress are more resistant to defect formation during fiber processing and handling. Although coatings with high tear strength and/or high critical stress have been described in the prior art, such coatings also exhibit a high Young's modulus and fail to provide the superior microbending performance of the present coatings when used as coatings for optical fibers. The coatings of the present disclosure, in contrast, combine a low Young's modulus with high tear strength and/or high critical stress and thus provide desirable performance attributes for primary fiber coatings.

Tear strength (G_{c}) is related to the force required to break the coating when the coating is under tension. The technique is described more fully below and with the technique, tear strength can be calculated from Eq. (1):

$${G}_{c} = \frac{{( \frac{{F}_{break}}{B \cdot d} \cdot C \cdot \sqrt{π \frac{b}{2}} )}^{2}}{S} \qquad ( 1 )$$

where F_{break} is the force at break, b is the slit length, d is the film thickness, B is the width of the test piece. B and b are instrument parameters with values given below. S is the segment modulus calculated from the stresses at elongations of 0.05% and 2%, and C is a sample geometry factor defined as follows for the technique used herein to determine tear strength:

$$C = \sqrt{\frac{1}{cos ( \frac{π b}{2 B} )}} \qquad ( 2 )$$

The critical stress of a coating represents the cohesive strength of the coating and corresponds to the magnitude of stress that the coating can endure prior to cohesive failure. Critical stress corresponds to the tensile stress needed to enlarge a defect cavity of a given size and reflects a balance between the rate of energy released upon enlargement of a defect cavity and the rate of energy required to form the surface of the tear in the coating resulting from enlargement of the defect cavity. For stresses above the critical stress, the rate of release of energy upon enlargement of the defect cavity exceeds the rate of energy required to form the surface of the tear and crack propagation occurs spontaneously. The critical stress is influenced by mechanical properties of the coating, most notably the Young's modulus (E) and tear strength (G_{c}) of the coating. In the limit where the ratio G_{c}/Er₀<<1, coating critical stress (σ_{c}) is given by:

$${σ}_{c} = {( \frac{π {G}_{c} E}{3 {r}_{0}} )}^{1 / 2} \qquad ( 3 )$$

where G_{c} is the coating tear strength, E is the coating Young's modulus and r₀ is the size of the defect cavity in the coating. The presence of defect cavities in the coating is a consequence of thermal stresses induced during cooling at the draw and mechanical stresses that are induced during screening of the fiber during processing. For purposes of this description based on observations of fiber coatings typical of the art, the defect cavity is assumed to have a spherical shape where r₀ corresponds to the radius of the sphere and is equal to 10 μm. Eq. (3) shows that in the limit where the ratio G_{c}/Er₀<<1, the critical stress is influenced by both the Young's modulus and tear strength of the coating according to a power law formula with exponent 0.5.

Eqs. (4) and (5) provide expressions that are used to estimate critical stress over the full range of the ratio G_{c}/Er₀:

$$\begin{matrix}{σ}_{c} = \frac{E}{6} [ 5 - ( \frac{4}{λ} ) - ( \frac{1}{{λ}^{2}} ) ] & ( 4 ) \\ \frac{{G}_{c}}{{Er}_{0}} = \frac{4}{9 π} ( 2 {λ}^{2} + \frac{1}{{λ}^{4}} - 3 ) & ( 5 )\end{matrix}$$

where λ>1 is the stretch ratio of the deformed cavity surface. In the limit of large stretch ratio λ, Eq. (5) indicates that the ratio

$$\frac{{G}_{c}}{{Er}_{0}} ≫ 1 \qquad ( 7 )$$

and Eq. (4) indicates that critical stress becomes

$${σ}_{c} = \frac{5 E}{6} \qquad ( 8 )$$

Eq. (8) indicates that in the limit where

$$\frac{{G}_{c}}{{Er}_{0}} ≫ 1 ,$$

critical stress σ_{c} becomes independent of tear strength G_{c} and depends only on Young's modulus E.

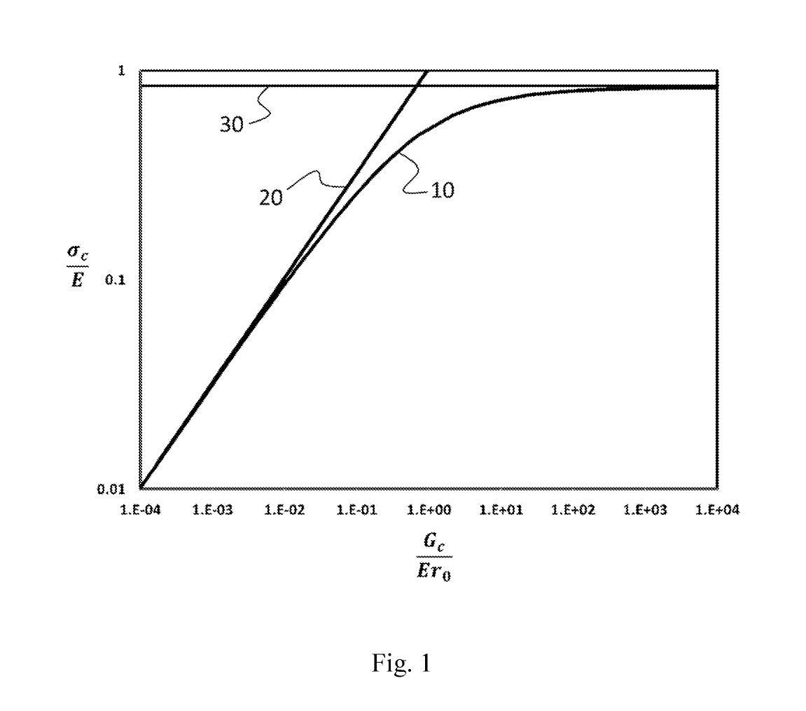

FIG. 1 illustrates the dependence of

$$\frac{{σ}_{c}}{E} on \frac{{G}_{c}}{{Er}_{0}}$$

on a logarithmic scale. Trace 10 shows the general dependence represented by Eqs. (4) and (5). Trace 20 shows the limiting case represented by Eq. (3) and trace 30 shows the limiting case represented by Eq. (8).

Eqs. (3)-(5) and FIG. 1 indicate that in order to increase critical stress, it is necessary to obtain coatings with high values of the ratios G_{c}/E and G_{c}/Er₀. With coating compositions that include the oligomeric material of the present disclosure, these ratios can be varied and as shown in the Examples below, it becomes possible to get high values of critical stress even for small values of Young's modulus. The overall result is a fiber coating that provides excellent microbending properties along with high resistance to defect formation and cohesive failure when the fiber is subjected to stresses arising during the fiber drawing and screening processes.

In various embodiments, coatings or cured products prepared from a coating composition that includes an oligomeric material in accordance with the present disclosure have a Young's modulus (E) of less than 1.0 MPa, or less than 0.8 MPa, or less than 0.7 MPa, or less than 0.6 MPa, or less than 0.5 MPa, or in the range from 0.1 MPa-1.0 MPa, or in the range from 0.3 MPa-1.0 MPa, or in the range from 0.45 MPa-1.0 MPa, or in the range from 0.2 MPa-0.9 MPa, or in the range from 0.3 MPa-0.8 MPa when configured as a film according to the preparation and test procedure described in the Examples below.

In various embodiments, coatings or cured products prepared from a coating composition that includes an oligomeric material in accordance with the present disclosure have a tear strength (G_{c}) of at least 30 J/m², or at least 35 J/m², or at least 40 J/m², or at least 45 J/m², or at least 50 J/m², or at least 55 J/m², or in the range from 30 J/m²-70 J/m², or in the range from 35 J/m²-65 J/m², or in the range from 40 J/m²-60 J/m², when configured as a film according to the procedure described in the Examples below.

In various embodiments, coatings or cured products prepared from a coating composition that includes an oligomeric material in accordance with the present disclosure have a critical stress (σ_{c}), as calculated by Eqs. (4) and (5) for a defect cavity size r₀=10 μm and a Young's modulus and tear strength determined according to the procedure described in the Examples below, of at least 0.40 MPa, or at least 0.45 MPa, or at least 0.50 MPa, or at least 0.55 MPa, or at least 0.60 MPa, or in the range from 0.40 MPa-0.75 MPa, or in the range from 0.45 MPa-0.70 MPa, or in the range from 0.45 MPa-0.65 MPa, or in the range from 0.50 MPa-0.65 MPa.

In various embodiments, coatings or cured products prepared from a coating composition that includes an oligomeric material in accordance with the present disclosure have a ratio of tear strength to Young's modulus (G_{c}/E) of at least 50 μm, at least 60 μm, or at least 75 μm, or at least 100 μm, or at least 125 μm, or at least 150 μm, or in the range from 50 μm-200 μm, or in the range from 60 μm-175 μm, or in the range from 70 μm-150 μm, or in the range from 80-130 μm, where tear strength and Young's modulus are determined according to the procedure described in the Examples below.

Coatings or cured products prepared from a coating composition that includes an oligomeric material in accordance with the present disclosure have a ratio (G_{c}/Er₀), for a defect cavity size r₀=10 μm, of at least 5.0 μm, at least 6.0 μm, or at least 7.5 μm, or at least 10.0 μm, or at least 12.5 μm, or at least 15.0 μm, or in the range from 5.0 μm-20.0 μm, or in the range from 6.0 μm-17.5 μm, or in the range from 7.0 μm-15.0 μm, or in the range from 8.0 μm-13.0 μm, where tear strength and Young's modulus are determined according to the procedure described in the Examples below.

In various embodiments, coatings or cured products prepared from a coating composition that includes an oligomeric material in accordance with the present disclosure have a Young's modulus of less than 1.0 MPa with a tear strength of at least 35 J/m², or a Young's modulus of less than 0.8 MPa with a tear strength of at least 35 J/m², or a Young's modulus of less than 0.6 MPa with a tear strength of at least 35 J/m², or a Young's modulus of less than 0.5 MPa with a tear strength of at least 35 J/m², or a Young's modulus of less than 1.0 MPa with a tear strength of at least 45 J/m², or a Young's modulus of less than 0.8 MPa with a tear strength of at least 45 J/m², or a Young's modulus of less than 0.6 MPa with a tear strength of at least 45 J/m², or a Young's modulus of less than 0.5 MPa with a tear strength of at least 45 J/m², or a Young's modulus of less than 1.0 MPa with a tear strength of at least 55 J/m², or a Young's modulus of less than 0.8 MPa with a tear strength of at least 55 J/m², or a Young's modulus of less than 0.6 MPa with a tear strength of at least 55 J/m², or a Young's modulus of less than 0.5 MPa with a tear strength of at least 55 J/m², where tear strength and Young's modulus are determined according to the procedure described in the Examples below.

In various embodiments, coatings or cured products prepared from a coating composition that includes an oligomeric material in accordance with the present disclosure have a Young's modulus in the range from 0.1 MPa-1.0 MPa with a tear strength in the range from 35 J/m²-75 J/m², or a Young's modulus in the range from 0.45 MPa-1.0 MPa with a tear strength in the range from 35 J/m²-75 J/m², or a Young's modulus in the range from 0.3 MPa-0.8 MPa with a tear strength in the range from 35 J/m²-75 J/m², or a Young's modulus in the range from 0.1 MPa-1.0 MPa with a tear strength in the range from 45 J/m²-70 J/m², or a Young's modulus in the range from 0.45 MPa-1.0 MPa with a tear strength in the range from 45 J/m²-70 J/m², or a Young's modulus in the range from 0.3 MPa-0.8 MPa with a tear strength in the range from 45 J/m²-70 J/m², or a Young's modulus in the range from 0.1 MPa-1.0 MPa with a tear strength in the range from 50 J/m²-65 J/m², or a Young's modulus in the range from 0.45 MPa-1.0 MPa with a tear strength in the range from 50 J/m²-65 J/m², or a Young's modulus in the range from 0.3 MPa-0.8 MPa with a tear strength in the range from 50 J/m²-65 J/m², where tear strength and Young's modulus are determined according to the procedure described in the Examples below.

In various embodiments, coatings or cured products prepared from a coating composition that includes an oligomeric material in accordance with the present disclosure have a Young's modulus of less than 1.0 MPa with a ratio G_{c}/E of at least 50 μm, or a Young's modulus of less than 1.0 MPa with a ratio G_{c}/E of at least 75 μm, or a Young's modulus of less than 1.0 MPa with a ratio G_{c}/E of at least 100 μm, or a Young's modulus of less than 0.8 MPa with a ratio G_{c}/E of at least 50 μm, or a Young's modulus of less than 0.8 MPa with a ratio G_{c}/E of at least 75 μm, or a Young's modulus of less than 0.8 MPa with a ratio G_{c}/E of at least 100 μm, or a Young's modulus of less than 0.6 MPa with a ratio G_{c}/E of at least 50 μm, or a Young's modulus of less than 0.6 MPa with a ratio G_{c}/E of at least 75 μm, or a Young's modulus of less than 0.6 MPa with a ratio G_{c}/E of at least 100 μm, or a Young's modulus of less than 0.5 MPa with a ratio G_{c}/E of at least 50 μm, or a Young's modulus of less than 0.5 MPa with a ratio G_{c}/E of at least 75 μm, or a Young's modulus of less than 0.5 MPa with a ratio G_{c}/E of at least 100 μm, where tear strength and Young's modulus are determined according to the procedure described in the Examples below.

In various embodiments, coatings or cured products prepared from a coating composition that includes an oligomeric material in accordance with the present disclosure have a Young's modulus in the range from 0.1 MPa-1.0 MPa with a ratio G_{c}/E in the range from 50 μm-200 μm, or a Young's modulus in the range from 0.1 MPa-1.0 MPa with a ratio G_{c}/E in the range from 60 μm-175 μm, or a Young's modulus in the range from 0.1 MPa-1.0 MPa with a ratio G_{c}/E in the range from 80 μm-130 μm, or a Young's modulus in the range from 0.45 MPa-1.0 MPa with a ratio G_{c}/E in the range from 50 μm-200 μm, or a Young's modulus in the range from 0.45 MPa-1.0 MPa with a ratio G_{c}/E in the range from 60 μm-175 μm, or a Young's modulus in the range from 0.45 MPa-1.0 MPa with a ratio G_{c}/E in the range from 80 μm-130 μm, a Young's modulus in the range from 0.3 MPa-0.8 MPa with a ratio G_{c}/E in the range from 50 μm-200 μm, or a Young's modulus in the range from 0.3 MPa-0.8 MPa with a ratio G_{c}/E in the range from 60 μm-175 μm, or a Young's modulus in the range from 0.3 MPa-0.8 MPa with a ratio G_{c}/E in the range from 80 μm-130 μm, where tear strength and Young's modulus are determined according to the procedure described in the Examples below.

In various embodiments, coatings or cured products prepared from a coating composition that includes an oligomeric material in accordance with the present disclosure have a tear strength of at least 35 J/m² with a ratio G_{c}/E of at least 50 μm, or a tear strength of at least 35 J/m² with a ratio G_{c}/E of at least 75 μm, or a tear strength of at least 35 J/m² with a ratio G_{c}/E of at least 100 μm, or a tear strength of at least 45 J/m² with a ratio G_{c}/E of at least 50 μm, or a tear strength of at least 45 J/m² with a ratio G_{c}/E of at least 75 μm, or a tear strength of at least 45 J/m² with a ratio G_{c}/E of at least 100 μm, a tear strength of at least 55 J/m² with a ratio G_{c}/E of at least 50 μm, or a tear strength of at least 55 J/m² with a ratio G_{c}/E of at least 75 μm, or a tear strength of at least 55 J/m² with a ratio G_{c}/E of at least 100 μm, where tear strength and Young's modulus are determined according to the procedure described in the Examples below.

In various embodiments, coatings or cured products prepared from a coating composition that includes an oligomeric material in accordance with the present disclosure have a tear strength in the range from 35 J/m²-75 J/m² with a ratio G_{c}/E in the range from 50 μm-200 μm, or a tear strength in the range from 35 J/m²-75 J/m² with a ratio G_{c}/E in the range from 60 μm-175 μm, or a tear strength in the range from 35 J/m²-75 J/m² with a ratio G_{c}/E in the range from 80 μm-130 μm, or a tear strength in the range from 45 J/m²-70 J/m² with a ratio G_{c}/E in the range from 50 μm-200 μm, or a tear strength in the range from 45 J/m²-70 J/m² with a ratio G_{c}/E in the range from 60 μm-175 μm, or a tear strength in the range from 45 J/m²-70 J/m² with a ratio G_{c}/E in the range from 80 μm-130 μm, or a tear strength in the range from 50 J/m²-65 J/m² with a ratio G_{c}/E in the range from 50 μm-200 μm, or a tear strength in the range from 50 J/m²-65 J/m² with a ratio G_{c}/E in the range from 60 μm-175 μm, or a tear strength in the range from 50 J/m²-65 J/m² with a ratio G_{c}/E in the range from 80 μm-130 μm, where tear strength and Young's modulus are determined according to the procedure described in the Examples below.

In various embodiments, coatings or cured products prepared from a coating composition that includes an oligomeric material in accordance with the present disclosure have a Young's modulus of less than 1.0 MPa with a critical stress, for a defect cavity size r₀=10 μm, of at least 0.40 MPa; or a Young's modulus of less than 1.0 MPa with a critical stress, for a defect cavity size r₀=10 μm, of at least 0.50 MPa; or a Young's modulus of less than 1.0 MPa with a critical stress, for a defect cavity size r₀=10 μm, of at least 0.60 MPa; or a Young's modulus of less than 0.8 MPa with a critical stress, for a defect cavity size r₀=10 μm, of at least 0.40 MPa; or a Young's modulus of less than 0.8 MPa with a critical stress, for a defect cavity size r₀=10 μm, of at least 0.50 MPa; or a Young's modulus of less than 0.8 MPa with a critical stress, for a defect cavity size r₀=10 μm, of at least 0.60 MPa; or a Young's modulus of less than 0.6 MPa with a critical stress, for a defect cavity size r₀=10 μm, of at least 0.40 MPa; or a Young's modulus of less than 0.6 MPa with a critical stress, for a defect cavity size r₀=10 μm, of at least 0.50 MPa; a Young's modulus of less than 0.6 MPa with a critical stress, for a defect cavity size r₀=10 μm, of at least 0.60 MPa; or a Young's modulus of less than 0.5 MPa with a critical stress, for a defect cavity size r₀=10 μm, of at least 0.40 MPa; or a Young's modulus of less than 0.5 MPa with a critical stress, for a defect cavity size r₀=10 μm, of at least 0.50 MPa; or a Young's modulus of less than 0.5 MPa with a critical stress, for a defect cavity size r₀=10 μm, of at least 0.60 MPa, where tear strength and Young's modulus are determined according to the procedure described in the Examples below.

In various embodiments, coatings or cured products prepared from a coating composition that includes an oligomeric material in accordance with the present disclosure have a Young's modulus in the range from 0.1 MPa-1.0 MPa with a critical stress, for a defect cavity size r₀=10 μm, in the range from 0.40 MPa-0.75 MPa; or a Young's modulus in the range from 0.1 MPa-1.0 MPa with a critical stress, for a defect cavity size r₀=10 μm, in the range from 0.45 MPa-0.70 MPa; or a Young's modulus in the range from 0.1 MPa-1.0 MPa with a critical stress, for a defect cavity size r₀=10 μm, in the range from 0.50 MPa-0.65 MPa; or a Young's modulus in the range from 0.45 MPa-1.0 MPa with a critical stress, for a defect cavity size r₀=10 μm, in the range from 0.40 MPa-0.75 MPa; or a Young's modulus in the range from 0.45 MPa-1.0 MPa with a critical stress, for a defect cavity size r₀=10 μm, in the range from 0.45 MPa-0.70 MPa; or a Young's modulus in the range from 0.45 MPa-1.0 MPa with a critical stress, for a defect cavity size r₀=10 μm, in the range from 0.50 MPa-0.65 MPa; or a Young's modulus in the range from 0.3 MPa-0.8 MPa with a critical stress, for a defect cavity size r₀=10 μm, in the range from 0.40 MPa-0.75 MPa; or a Young's modulus in the range from 0.3 MPa-0.8 MPa with a critical stress, for a defect cavity size r₀=10 μm, in the range from 0.45 MPa-0.70 MPa; or a Young's modulus in the range from 0.3 MPa-0.8 MPa with a critical stress, for a defect cavity size r₀=10 μm, in the range from 0.50 MPa-0.65 MPa, where tear strength and Young's modulus are determined according to the procedure described in the Examples below.

In various embodiments, coatings or cured products prepared from a coating composition that includes an oligomeric material in accordance with the present disclosure have a tear strength of at least 35 J/m² with a critical stress, for a defect cavity size r₀=10 μm, of at least 0.40 MPa; or a tear strength of at least 35 J/m² with a critical stress, for a defect cavity size r₀=10 μm, of at least 0.50 MPa; or a tear strength of at least 35 J/m² with a critical stress, for a defect cavity size r₀=10 μm, of at least 0.60 MPa; or a tear strength of at least 45 J/m² with a critical stress, for a defect cavity size r₀=10 μm, of at least 0.40 MPa; or a tear strength of at least 45 J/m² with a critical stress, for a defect cavity size r₀=10 μm, of at least 0.50 MPa; or a tear strength of at least 45 J/m² with a critical stress, for a defect cavity size r₀=10 μm, of at least 0.60 MPa; or a tear strength of at least 55 J/m² with a critical stress, for a defect cavity size r₀=10 μm, of at least 0.40 MPa; or a tear strength of at least 55 J/m² with a critical stress, for a defect cavity size r₀=10 μm, of at least 0.50 MPa; a tear strength of at least 55 J/m² with a critical stress, for a defect cavity size r₀=10 μm, of at least 0.60 MPa, where tear strength and Young's modulus are determined according to the procedure described in the Examples below.

In various embodiments, coatings or cured products prepared from a coating composition that includes an oligomeric material in accordance with the present disclosure have a tear strength in the range from 35 J/m²-75 J/m² with a critical stress, for a defect cavity size r₀=10 μm, in the range from 0.40 MPa-0.75 MPa; or a tear strength in the range from 35 J/m²-75 J/m² with a critical stress, for a defect cavity size r₀=10 μm, in the range from 0.45 MPa-0.70 MPa; or a tear strength in the range from 35 J/m²-75 J/m² with a critical stress, for a defect cavity size r₀=10 μm, in the range from 0.50 MPa-0.65 MPa; or a tear strength in the range from 45 J/m²-70 J/m² with a critical stress, for a defect cavity size r₀=10 μm, in the range from 0.40 MPa-0.75 MPa; or a tear strength in the range from 45 J/m²-70 J/m² with a critical stress, for a defect cavity size r₀=10 μm, in the range from 0.45 MPa-0.70 MPa; or a tear strength in the range from 45 J/m²-70 J/m² with a critical stress, for a defect cavity size r₀=10 μm, in the range from 0.50 MPa-0.65 MPa; or a tear strength in the range from 50 J/m²-65 J/m² with a critical stress, for a defect cavity size r₀=10 μm, in the range from 0.40 MPa-0.75 MPa; or a tear strength in the range from 50 J/m²-65 J/m² with a critical stress, for a defect cavity size r₀=10 μm, in the range from 0.45 MPa-0.70 MPa; or a tear strength in the range from 50 J/m²-65 J/m² with a critical stress, for a defect cavity size r₀=10 μm, in the range from 0.50 MPa-0.65 MPa, where tear strength and Young's modulus are determined according to the procedure described in the Examples below.

In various embodiments, coatings or cured products prepared from a coating composition that includes an oligomeric material in accordance with the present disclosure have a ratio G_{c}/E of at least 50 μm with a critical stress, for a defect cavity size r₀=10 μm, of at least 0.40 MPa; or a ratio G_{c}/E of at least 50 μm with a critical stress, for a defect cavity size r₀=10 μm, of at least 0.50 MPa; or a ratio G_{c}/E of at least 50 μm with a critical stress, for a defect cavity size r₀=10 μm, of at least 0.60 MPa; or a ratio G_{c}/E of at least 75 μm with a critical stress, for a defect cavity size r₀=10 μm, of at least 0.40 MPa; or a ratio G_{c}/E of at least 75 μm with a critical stress, for a defect cavity size r₀=10 μm, of at least 0.50 MPa; or a ratio G_{c}/E of at least 75 μm with a critical stress, for a defect cavity size r₀=10 μm, of at least 0.60 MPa; or a ratio G_{c}/E of at least 100 μm with a critical stress, for a defect cavity size r₀=10 μm, of at least 0.40 MPa; or a ratio G_{c}/E of at least 100 μm with a critical stress, for a defect cavity size r₀=10 μm, of at least 0.50 MPa; a ratio G_{c}/E of at least 100 μm with a critical stress, for a defect cavity size r₀=10 μm, of at least 0.60 MPa, where tear strength and Young's modulus are determined according to the procedure described in the Examples below.

In various embodiments, coatings or cured products prepared from a coating composition that includes an oligomeric material in accordance with the present disclosure have a ratio G_{c}/E in the range from 50 μm-200 μm with a critical stress, for a defect cavity size r₀=10 μm, in the range from 0.40 MPa-0.75 MPa; or a ratio G_{c}/E in the range from 50 μm-200 μm with a critical stress, for a defect cavity size r₀=10 μm, in the range from 0.45 MPa-0.70 MPa; or a ratio G_{c}/E in the range from 50 μm-200 μm with a critical stress, for a defect cavity size r₀=10 μm, in the range from 0.50 MPa-0.65 MPa; or a ratio G_{c}/E in the range from 60 μm-175 μm with a critical stress, for a defect cavity size r₀=10 μm, in the range from 0.40 MPa-0.75 MPa; or a ratio G_{c}/E in the range from 60 μm-175 μm with a critical stress, for a defect cavity size r₀=10 μm, in the range from 0.45 MPa-0.70 MPa; or a ratio G_{c}/E in the range from 60 μm-175 μm with a critical stress, for a defect cavity size r₀=10 μm, in the range from 0.50 MPa-0.65 MPa; or a ratio G_{c}/E in the range from 80 μm-130 μm with a critical stress, for a defect cavity size r₀=10 μm, in the range from 0.40 MPa-0.75 MPa; or a ratio G_{c}/E in the range from 80 μm-130 μm with a critical stress, for a defect cavity size r₀=10 μm, in the range from 0.45 MPa-0.70 MPa; or a ratio G_{c}/E in the range from 80 μm-130 μm with a critical stress, for a defect cavity size r₀=10 μm, in the range from 0.50 MPa-0.65 MPa, where tear strength and Young's modulus are determined according to the procedure described in the Examples below.

The present disclosure extends to optical fibers coated with the cured product of coating compositions that include the present oligomeric materials. The optical fiber includes a glass waveguide with a higher index glass core region surrounded by a lower index glass cladding region. A coating formed as a cured product of the present coating compositions surrounds the glass cladding. The cured product of the present coating compositions may function as the primary coating of the fiber. The fiber may include a secondary coating. The fiber may withstand screening at a level of at least 200 kpsi without forming defects in the coating when the coating is formed as the cured product of the present coating composition. The fiber may withstand two or more screenings at a level of at least 100 kpsi without forming defects in the coating when the coating is formed as the cured product of the present coating composition.

### Examples

Several illustrative coatings prepared from coating compositions that included an oligomeric material in accordance with the present disclosure were prepared and tested. The tests included measurements of Young's modulus, tear strength, and critical stress. The preparation of oligomeric materials, description of the components of the coating compositions, processing conditions used to form oligomeric materials and coatings, test methodologies, and test results are described hereinbelow.

Oligomeric Materials.

The coating compositions are curable coating compositions that included an oligomeric material of the type disclosed herein. For purposes of illustration, preparation of exemplary oligomeric materials from H12MDI (4,4′-methylene bis(cyclohexyl isocyanate), PPG4000 (polypropylene glycol with Mₙ˜4000 g/mol) and HEA (2-hydroxyethyl acrylate) in accordance with the reaction scheme hereinabove is described. All reagents were used as supplied by the manufacturer and were not subjected to further purification. H12MDI was obtained from ALDRICH. PPG4000 was obtained from COVESTRO and was certified to have an unsaturation of 0.004 meq/g as determined by the method described in the standard ASTM D4671-16. HEA was obtained from KOWA.

The relative amounts of the reactants and reaction conditions were varied to obtain a series of six oligomeric materials. Oligomeric materials with different initial molar ratios of the constituents were prepared with molar ratios of the reactants satisfying H12MDI:HEA:PPG4000=n:m:p, where n was in the range from 3.0 to 4.0, m was in the range from 1.5n-3 to 2.5n-5, and p=2. In the reactions used to form the oligomeric materials, dibutyltin dilaurate was used as a catalyst (at a level of 160 ppm based on the mass of the initial reaction mixture) and 2,6-di-tert-butyl-4-methylphenol (BHT) was used as an inhibitor (at a level of 400 ppm based on the mass of the initial reaction mixture).

The amounts of the reactants used to prepare each of the six oligomeric materials are summarized in Table 1 below. The six oligomeric materials are identified by separate Sample numbers 1-6. Corresponding sample numbers will be used herein to refer to coating compositions and cured films formed from coating compositions that individually contain each of the six oligomeric materials. The corresponding mole numbers used in the preparation of each of the six samples are listed in Table 2 below. The mole numbers are normalized to set the mole number p of PPG4000 to 2.0.

TABLE 1
Reactants and Amounts for Exemplary Oligomeric Materials 1-6

| Sample | H12MDI (g) | HEA (g) | PPG4000 (g) |
|---|---|---|---|
| 1 | 22 | 6.5 | 221.5 |
| 2 | 26.1 | 10.6 | 213.3 |
| 3 | 26.1 | 10.6 | 213.3 |
| 4 | 27.8 | 12.3 | 209.9 |
| 5 | 27.8 | 12.3 | 209.9 |
| 6 | 22 | 6.5 | 221.5 |

TABLE 2
Mole Numbers for Oligomeric Material Samples 1-6

| | H12MDI | HEA Mole | PPG4000 | Di-adduct |
|---|---|---|---|---|
| Sample | Mole Number (n) | Number (m) | Mole Number (p) | (wt %) |
| 1 | 3.0 | 2.0 | 2.0 | 1.3 |
| 2 | 3.7 | 3.4 | 2.0 | 3.7 |
| 3 | 3.7 | 3.4 | 2.0 | 3.7 |
| 4 | 4.0 | 4.0 | 2.0 | 5.0 |
| 5 | 4.0 | 4.0 | 2.0 | 5.0 |
| 6 | 3.0 | 2.0 | 2.0 | 1.3 |

The oligomeric materials were prepared by mixing 4,4′-methylene bis(cyclohexyl isocyanate), dibutyltin dilaurate and 2,6-di-tert-butyl-4 methylphenol at room temperature in a 500 mL flask. The 500 mL flask was equipped with a thermometer, a CaCl₂ drying tube, and a stirrer. While continuously stirring the contents of the flask, PPG4000 was added over a time period of 30-40 minutes using an addition funnel. The internal temperature of the reaction mixture was monitored as the PPG4000 was added and the introduction of PPG4000 was controlled to prevent excess heating (arising from the exothermic nature of the reaction). After the PPG4000 was added, the reaction mixture was heated in an oil bath at about 70° C.-75° C. for about 1-1½ hours. At various intervals, samples of the reaction mixture were retrieved for analysis by infrared spectroscopy (FTIR) to monitor the progress of the reaction by determining the concentration of unreacted isocyanate groups. The concentration of unreacted isocyanate groups was assessed based on the intensity of a characteristic isocyanate stretching mode near 2265 cm⁻¹. The flask was removed from the oil bath and its contents were allowed to cool to below 65° C. Addition of supplemental HEA was conducted to insure complete quenching of isocyanate groups. The supplemental HEA was added dropwise over 2-5 minutes using an addition funnel. After addition of the supplemental HEA, the flask was returned to the oil bath and its contents were again heated to about 70° C.-75° C. for about 1-1½ hours. FTIR analysis was conducted on the reaction mixture to assess the presence of isocyanate groups and the process was repeated until enough supplemental HEA was added to fully react any unreacted isocyanate groups. The reaction was deemed complete when no appreciable isocyanate stretching intensity was detected in the FTIR measurement. The HEA amounts listed in Table 1 include the initial amount of HEA in the composition and any amount of supplemental HEA needed to quench unreacted isocyanate groups.

The concentration (wt %) of di-adduct compound was determined by gel permeation chromatography (GPC). A Waters Alliance 2690 GPC instrument was used to determine the di-adduct concentration. The mobile phase was THF. The instrument included a series of three Polymer Labs columns. Each column had a length of 300 mm and an inside diameter of 7.5 mm. Two of the columns (columns 1 and 2) were sold under Part No. PL1110-6504 by Agilent Technologies and were packed with PLgel Mixed D stationary phase (polystyrene divinyl benzene copolymer, average particle size=5 μm, specified molecular weight range=200-400,000 g/mol). The third column (column 3) was sold under Part No. PL1110-6520 by Agilent Technologies and was packed with PLgel 100A stationary phase (polystyrene divinyl benzene copolymer, average particle size=5 μm, specified molecular weight range=up to 4,000 g/mol). The columns were calibrated with polystyrene standards ranging from 162-6,980,000 g/mol using EasiCal PS-1 & 2 polymer calibrant kits (Agilent Technologies Part Nos. PL2010-505 and PL2010-0601). The GPC instrument was operated under the following conditions: flow rate=1.0 mL/min, column temperature=40° C., injection volume=100 and run time=35 min (isocratic conditions). The detector was a Waters Alliance 2410 differential refractometer operated at 40° C. and sensitivity level 4. The samples were injected twice along with a THF+0.05% toluene blank.

The amount (wt %) of di-adduct in the oligomers prepared in the present disclosure was quantified using the preceding GPC system and technique. A calibration curve was obtained using standard solutions containing known amounts of the di-adduct compound (HEA˜H12MDI˜HEA) in THF. Standard solutions with di-adduct concentrations of 115.2 μg/g, 462.6 μg/g, 825.1 μg/g, and 4180 μg/g were prepared. (As used herein, the dimension “μg/g” refers to μg of di-adduct per gram of total solution (di-adduct+THF)). Two 100 μL aliquots of each di-adduct standard solution were injected into the column to obtain the calibration curve. The retention time of the di-adduct was approximately 23 min and the area of the GPC peak of the di-adduct was measured and correlated with di-adduct concentration. A linear correlation of peak area as a function of di-adduct concentration was obtained (correlation coefficient (R²)=0.999564).

The di-adduct concentration in the oligomeric materials prepared herein was determined using the calibration. Samples were prepared by diluting ˜0.10 g of oligomeric material in THF to obtain a ˜1.5 g test solution. The test solution was run through the GPC instrument and the area of the peak associated with the di-adduct compound was determined. The di-adduct concentration in units of μg/g was obtained from the peak area and the calibration curve, and was converted to wt % by multiplying by the weight (g) of the test solution and dividing by the weight of the sample of oligomeric material before dilution with THF. The wt % of di-adduct compound present in each of the six oligomeric materials prepared in this example are reported in Table 3.

Through variation in the relative mole ratios of H12MDI, HEA, and PPG4000, the illustrative oligomeric materials include a polyether urethane compound of the type shown in molecular formula (IV) hereinabove and an enhanced concentration of di-adduct compound of the type shown in molecular formula (V) hereinabove. As described more fully hereinbelow, coatings formed using oligomeric materials that contain the di-adduct compound in amounts of at least 2.50 wt % have significantly improved tear strength and/or critical stress (relative to coatings formed from polyether urethane acrylate compounds alone or polyether urethane acrylate compounds combined with lesser amounts of di-adduct compound) while maintaining a favorable Young's modulus for primary coatings of optical fibers.

Preparation of Coating Compositions.

Oligomeric materials corresponding to Samples 1-6 were separately combined with other components to form a series of six coating compositions. The amount of each component in the coating composition is listed in Table 4 below. The entry in Table 4 for the oligomeric material includes the combined amount of polyether urethane acrylate compound and di-adduct compound present in the oligomeric material. A separate coating composition was made for each of the six exemplary oligomeric materials corresponding to Samples 1-6, where the amount of di-adduct compound in the oligomeric material corresponded to the amount listed in Table 3.

TABLE 4
Coating Composition

| Component | Amount |
|---|---|
| Oligomeric Material | 49.10 wt % |
| Sartomer SR504 | 45.66 wt % |
| V-CAP/RC | 1.96 wt % |
| TPO | 1.47 wt % |
| 1035 | 0.98 wt % |
| adhesion promoter | 0.79 wt % |
| Tetrathiol | 0.03 wt % |

Sartomer SR504 is ethoxylated(4)nonylphenol acrylate (available from Sartomer). V-CAP/RC is N-vinylcaprolactam (available from ISP Technologies). TPO is 2,4,6-trimethylbenzoyl)diphenyl phosphine oxide (available from BASF under the trade name Lucirin and functions as a photoinitiator). 1035 is thiodiethylene bis[3-(3,5-di-tert-butyl)-4-hydroxy-phenyl) propionate] (available from BASF under the trade name Irganox 1035) and functions as an antioxidant. The adhesion promoters were 3-acryloxypropyl trimethoxysilane (available from Gelest) and 3-mercaptopropyl trimethoxysilane (available from Aldrich). 3-acryloxypropyl trimethoxysilane was used for Samples 1, 3, and 5. 3-mercaptopropyl trimethoxysilane was used for Samples 2, 4, and 6. Tetrathiol is a catalyst quencher.

Various properties of films formed by curing coating compositions containing each of the six oligomeric materials were measured. A discussion of properties, methods of curing coating compositions to form films, and results follows.

Young's Modulus, Tensile Strength, % Elongation, and Glass Transition Temperature.

Young's modulus (E) was measured on films formed by the curing coating compositions listed in Table 4. Separate films were formed from coating compositions containing each of oligomeric material Samples 1-6. Wet films of the coating composition were cast on silicone release paper with the aid of a draw-down box having a gap thickness of about 0.005″. The wet films were cured with a UV dose of 1.2 J/cm² (measured over a wavelength range of 225-424 nm by a Light Bug model IL490 from International Light) by a Fusion Systems UV curing apparatus with a 600 W/in D-bulb (50% Power and approximately 12 ft/min belt speed) to yield cured coatings in film form. Cured film thickness was between about 0.0030″ and 0.0035″.

The films were allowed to age (23° C., 50% relative humidity) for at least 16 hours prior to testing. Film samples were cut to dimensions of 12.5 cm×13 mm using a cutting template and a scalpel. Young's modulus, tensile strength at break, and % elongation (% strain at break) were measured on the film samples using a MTS Sintech tensile test instrument following procedures set forth in ASTM Standard D882-97. Young's modulus is defined as the steepest slope of the beginning of the stress-strain curve. Films were tested at an elongation rate of 2.5 cm/min with the initial gauge length of 5.1 cm.

Glass transition temperatures were measured for the films by determining the peak of the tan δ curves obtained from a Seiko-5600 test instrument in tension. The test methodology is based on DMA (dynamic mechanical analysis). Film samples were cut to a length of 10 mm and a width of 10 mm. Film samples were individually inserted into the sample compartment of the test instrument cooled to approximately −85° C. Once the temperature was stable, a temperature ramp was run using the following parameters:
Frequency: 1 Hz
Strain: 0.3%
Heating Rate: 2° C./min.
Final Temperature: 150° C.
Initial Static Force=20.0 [g]
Static>Dynamic Force by=10.0 [%]

T_{g} is defined as the maximum of the tan δ peak, where the tan δ peak is defined as:

tan δ=E″/E′

where E″ is the loss modulus, which is proportional to the loss of energy as heat in a cycle of deformation, and E′ is the storage or elastic modulus, which is proportional to the energy stored in a cycle of deformation.

Tear Strength.

Tear strength (G_{c}) was measured with a MTS Sintech tensile tester. Each coating composition was cast on a glass plate with the aid of a draw-down box having a gap thickness of about 0.005″ and immediately cured under UV irradiation using a dose of 1 J/cm². The shape and dimensions of the cured films were prepared according to the International Standard ISO 816 (second edition 1983 Dec. 1) “Determination of tear strength of small test pieces (Delft test pieces)”. The cured films were conditioned at 23° C.±2° C. and 50% relative humidity (RH) for at least 16 hours. The initial gauge length was 5.0 cm and test speed was set at 0.1 mm/min. Three to five specimens of each film were tested. Tear strength (G_{c}) was calculated from Eqs. (1) and (2). For the test instrument used in the measurements, slit length b was 5.0 mm, width B of the test piece was 9.0 mm, and sample geometry factor C was 1.247.

Critical Stress.

Critical stress was calculated from Equations (4) and (5) using the measured values of Young's modulus (E) and tear strength (Gₑ). In the calculation, a defect cavity having a spherical shape and r₀=10 μm was assumed.

Cure Speed.

Cure speed is a measure of the rate of reaction of a coating composition. A UV rheology measurement method (real-time DMA (dynamic mechanical analysis) was used to assess cure speed. The dynamic mechanical shear properties of the coating compositions were measured in real time while exposing the compositions to UV curing radiation. The dynamic mechanical shear properties were measured using a parallel plate rheometer (model DHR-3, TA Instruments) equipped with a 395 nm UV LED attachment that was used to illuminate the coating composition to induce curing. A specimen of the coating composition was loaded between parallel upper and lower plates of the test instrument. The upper plate was a 20 mm diameter disposable aluminum plate and the lower plate was a 20 mm diameter quartz plate. A gap between the plates of 50 μm was used to provide a sample thickness of 50 μm for all tests. The UV light was emitted from an array of 395 nm LEDs centered directly below the quartz plate. The incident UV intensity was calibrated at the specimen location with measurements using a radiometer with a sensor head designed to fit over and in contact with the quartz plate (model ILT 1400, International Light Technologies). A cover was applied over the specimen to allow a nitrogen atmosphere to blanket the sample. Before starting the test, nitrogen was flowed through the cover for 2 min to establish an inert environment in the vicinity of the specimen coating composition. The test was then started by applying an oscillatory shear strain of 10% at 20 Hz frequency for 10 sec without UV light to establish a baseline. Data was collected every 25 msec during the test. After 10 sec, the UV light source was turned on for 15 sec at an intensity of 100 mW/cm². After the 15 sec exposure to 395 nm radiation, the measurement was continued with the LED turned off until the test ended at a total run time of 120 sec. The experiment was repeated two more times and average values of the test results were reported for three runs. All experiments were conducted under a nitrogen atmosphere at room temperature (approximately 20° C.). The TRIOS software package (TA Instruments) was used for data analysis, which included determination of G′−G″ crossover time and maximum value of the complex modulus (Gₘₐₓ*). The complex modulus G*=G′+iG″, where G′ is the shear storage modulus and G″ is the shear loss modulus. The G′−G″ crossover time is also referred to herein as the modulus crossover time or modulus gel time. As used herein, the maximum value of the complex modulus (Gₘₐₓ*) refers to the maximum value of the complex modulus G* observed in the 120 sec total run time of the measurement. Since complex modulus G* increases with cure time, the maximum value of the complex modulus (Gₘₐₓ*) corresponded essentially to the value of complex modulus G* at the end of the test (i.e. at a time of 120 sec).

As the curing reaction proceeds, the coating composition undergoes a transition from a viscous liquid state to a more elastic or rubbery state. In the initial viscous liquid state, the shear loss modulus is greater than the shear storage modulus. The transition to a more elastic or rubbery state is marked by a sharp increase in shear storage modulus and only a gradual increase in shear loss modulus. At some time following initiation of the curing reaction, the shear storage modulus equals the shear loss modulus. The time of reaction needed for the shear storage modulus to become equal to the shear loss modulus is referred to herein as the modulus crossover time or the G′−G″ crossover time. At times longer than the modulus crossover time, the shear storage modulus is greater than the shear loss modulus. The modulus crossover time corresponds approximately to the gelation point of the coating composition and is used herein as a measure of cure time. Shorter cure times correspond to faster cure speeds.

Degree of Cure.

Degree of cure is a measure of the extent to which the curing reaction proceeds. Before initiation of the curing reaction, the concentration of acrylate functional groups is high. As the curing reaction proceeds upon initiation, the concentration of acrylate functional groups decreases. A determination of the concentration of acrylate functional groups provides a measure of the extent of the curing reaction. The concentration of acrylate functional groups can be monitored before, after or at any time during the curing reaction.

The degree of cure was measured using the reacted Acrylate Unsaturation (% RAU) method. In the % RAU method, the concentration of acrylate functional groups is assessed by FTIR. Acrylate functional groups include a carbon-carbon double bond with a characteristic absorption frequency in the infrared centered near 810 cm⁻¹. The intensity of this characteristic acrylate band is proportional to the concentration of acrylate functional groups. As the curing reaction proceeds, the intensity of the characteristic acrylate band decreases and the magnitude of the decrease is a measure of the degree of cure at any point during the curing reaction.

% RAU was determined by measuring the area of the characteristic acrylate band at 810 cm⁻¹. The baseline for the measurement was taken as the tangent line through the absorption minima of the characteristic acrylate band. The area of the characteristic acrylate band was taken as the area of the band above the baseline. To account for background intensity and instrumental effects on the area measurement, the area of a reference band in the 750-780 cm⁻¹ region using the baseline of the characteristic acrylate band was measured. The spectral region of the reference band is outside of the absorption range of acrylate functional groups. The ratio R of the area of the characteristic acrylate band to the area of the reference band was determined. This ratio is proportional to the concentration of unreacted acrylated functional groups in the coating composition. The ratio is greatest for the coating composition before initiation of the curing reaction and decreases as the curing reaction proceeds.

% RAU is defined

$$\% RAU = \frac{( {R}_{L} - {R}_{F} ) \times 100}{{R}_{L}} \qquad ( 9 )$$

where R_{L} is the ratio R for the uncured coating composition and R_{F} is the ratio R for the cured product of the coating composition.

Results.

The tensile strength, % elongation, and glass transition temperature (T_{g}) for film Samples 1-6 are listed in Table 5.

TABLE 5
Tensile Strength, % Elongation, and T_{g} of Film Samples

| | Tensile Strength | | |
|---|---|---|---|
| Sample | (MPa) | % Elongation | T_{g} (° C.) |
| 1 | 0.51 | 137.9 | −22.0 |
| 2 | 0.44 | 173 | −26.0 |
| 3 | 0.86 | 132.8 | −26.0 |
| 4 | 0.45 | 122.3 | −24.1 |
| 5 | 0.56 | 157.4 | −23.0 |
| 6 | 0.33 | 311.9 | Not |
| | | | measured |

The Young's modulus (E), tear strength (G_{c}), and critical stress (σ_{c}) results for film Samples 1-6 are summarized in Table 6. Table 6 also includes the ratios

$$\frac{{G}_{c}}{E} and \frac{{G}_{c}}{{Er}_{0}} .$$

The ratio

$$\frac{{G}_{c}}{{Er}_{0}}$$

is dimensionless and was computed assuming a defect cavity dimension r₀=10 μm.

TABLE 6
Young's Modulus, Tear Strength, and Critical Stress of Film Samples

| | Young's | | | | Critical |
|---|---|---|---|---|---|
| Sample | Modulus (E) (MPa) | Tear Strength (G_{c}) (J/m²) | $\frac{{G}_{c}}{E} ( μ m )$ | $\frac{{G}_{c}}{E {r}_{0}}$ | Stress (σ_{c}) (MPa) |
| 1 | 0.72 | 57.9 | 80.4 | 8.04 | 0.51 |
| 2 | 0.57 | 56.1 | 98.4 | 9.84 | 0.41 |
| 3 | 1.0 | 47.6 | 47.6 | 4.76 | 0.68 |
| 4 | 0.71 | 39.8 | 56.1 | 5.61 | 0.48 |
| 5 | 0.72 | 39.6 | 55 | 5.5 | 0.49 |
| 6 | 0.33 | 66.4 | 201.2 | 20.12 | 0.25 |

The results of cure speed measurements are shown in Table 7 for Samples 1, 2, and 5. G′−G″ crossover time, maximum value of complex modulus (Gₘₐₓ*), and the maximum time rate of change of complex modulus

$$( {( \frac{{dG}^{*}}{dt} )}_{max} )$$

are reported.

TABLE 7
DMA Analysis

| | G′- G″ | | |
|---|---|---|---|
| Sample | crossover time (sec) | Gₘₐₓ* (kPa) | ${( \frac{d {G}^{*}}{d t} )}_{max} ( kPa \text{/} sec )$ |
| 1 | 0.18 | 205.2 | 503.3 |
| 2 | 0.24 | 182.8 | 336.5 |
| 5 | 0.23 | 209.1 | 386.1 |

The modulus crossover time as measured at room temperature by the procedure described herein (15 sec exposure of a 50 μm thick sample to 100 mW/cm² of 395 nm LED radiation while applying an oscillatory shear strain at 20 Hz frequency) for coating compositions disclosed herein is less than 1.5 sec, or less than 1.0 sec, or less than 0.5 sec, or less than 0.35 sec, or less than 0.25 sec, or less than 0.15 sec, or in the range from 0.10 sec-2.0 sec, or in the range from 0.15 sec-1.5 sec, or in the range from 0.20 sec-1.25 sec, or in the range from 0.25 sec-1.0 sec, or in the range from 0.25 sec-0.75 sec, or in the range from 0.15 sec-0.50 sec, or in the range from 0.15 sec-0.40 sec, or in the range from 0.20 sec-0.35 sec, or in the range from 0.20 sec-0.30 sec.

The maximum complex modulus (Gₘₐₓ*) as measured at room temperature by the procedure described herein (15 sec exposure of a 50 μm thick sample to 100 mW/cm² of 395 nm LED radiation while applying an oscillatory shear strain of 10% at 20 Hz frequency) for coating compositions disclosed herein is less than 400 kPa, or less than 300 kPa, or less than 200 kPa, or in the range from 100 kPa-400 kPa, or in the range from 150 kPa-300 kPa, or in the range from 160 kPa-250 kPa.

In one embodiment, the coating compositions disclosed herein are used to form primary coatings for optical fibers. In the following example, Samples 1-5 were used as coating compositions to form primary coating on optical fibers. Each of Samples 1-5 was separately applied as a primary coating composition to a glass optical fiber as the optical fiber was being drawn. The fiber draw speed was 50 m/s. The primary coating compositions were cured using a stack of five LED sources. Each LED source was operated at 395 nm and had an intensity of 12 W/cm². Subsequent to application and curing of Samples 1-5 as primary coating compositions, a secondary coating composition was applied to the cured primary coating and cured using UV sources to form a secondary coating layer. The draw conditions and LED cure processing conditions used for Samples 1-5 are shown in Table 8. Also shown in Table 8 are the % RAU of Samples 1-5 after curing, the in situ modulus for Samples 2, 3, and 5 after curing, and T_{g} of Samples 1-3 and 5 after curing.

TABLE 8
Curing Conditions During Fiber Draw

| | | In-Situ | |
|---|---|---|---|
| | | Modulus | |
| Sample | % RAU | (MPa) | T_{g} [° C.] |
| 1 | 100 | | −51.5 |
| 2 | 89.5 | 0.27 | −51.7 |
| 3 | 97.2 | 0.33 | −51.6 |
| 4 | 96.7 | | |
| 5 | 99.3 | 0.3 | −51.2 |

Modeled Samples.

The experimental Samples 1-6 and principles disclosed herein indicate that by varying the mole numbers n, m, and p, it is possible to control the relative amount of di-adduct compound in the oligomeric material as well as the properties of cured films formed from coating compositions that include the oligomeric material over a wide range. To further examine the effect of Young's modulus and tear strength on critical stress, a series of modeled Samples was considered. Modeled Samples are number 7-30. For each modeled Sample, a Young's modulus (E) and tear strength (G_{c}) were assumed and the ratio

$$\frac{{G}_{c}}{E} ,$$

the ratio

$$\frac{{G}_{c}}{{Er}_{0}} ,$$

and critical stress (σ_{c}) were calculated. For each value of Young's modulus (E), A defect cavity dimension r₀=10 μm was assumed. Critical stress was calculated using Eqs. (4) and (5). The results of the calculations are shown in Tables 9-11.

TABLE 9
Modeled Young's Modulus, Tear Strength, and Critical
Stress of Film Samples

| | Young's | Tear | | | Critical |
|---|---|---|---|---|---|
| Sample | Modulus (E) (MPa) | Strength (G_{c}) (J/m²) | $\frac{{G}_{c}}{E} ( μ m )$ | $\frac{{G}_{c}}{E {r}_{0}}$ | Stress (σ_{c}) (MPa) |
| 7 | 0.45 | 40 | 88.9 | 8.89 | 0.322 |
| 8 | 0.45 | 50 | 111.1 | 11.1 | 0.328 |
| 9 | 0.45 | 60 | 133.3 | 13.3 | 0.333 |
| 10 | 0.45 | 70 | 155.7 | 15.6 | 0.337 |
| 11 | 0.55 | 40 | 72.7 | 7.3 | 0.387 |
| 12 | 0.55 | 50 | 90.9 | 9.1 | 0.395 |
| 13 | 0.55 | 60 | 109.1 | 10.9 | 0.401 |
| 14 | 0.55 | 70 | 127.3 | 12.7 | 0.406 |

TABLE 10
Modeled Young's Modulus, Tear Strength, and Critical
Stress of Film Samples

| | Young's | Tear | | | Critical |
|---|---|---|---|---|---|
| Sample | Modulus (E) (MPa) | Strength (G_{c}) (J/m²) | $\frac{{G}_{c}}{E} ( μ m )$ | $\frac{{G}_{c}}{E {r}_{0}}$ | Stress (σ_{c}) (MPa) |
| 15 | 0.65 | 40 | 61.4 | 6.1 | 0.449 |
| 16 | 0.65 | 50 | 76.9 | 7.7 | 0.459 |
| 17 | 0.65 | 60 | 92.3 | 9.2 | 0.467 |
| 18 | 0.65 | 70 | 107.7 | 10.8 | 0.474 |
| 19 | 0.75 | 40 | 53.3 | 5.3 | 0.510 |
| 20 | 0.75 | 50 | 66.7 | 6.7 | 0.522 |
| 21 | 0.75 | 60 | 80.0 | 8.0 | 0.532 |
| 22 | 0.75 | 70 | 93.3 | 9.3 | 0.540 |

TABLE 11
Modeled Young's Modulus, Tear Strength, and Critical
Stress of Film Samples

| | Young's | Tear | | | Critical |
|---|---|---|---|---|---|
| Sample | Modulus (E) (Mpa) | Strength (G_{c}) (J/m²) | $\frac{{G}_{c}}{E} ( μ m )$ | $\frac{{G}_{c}}{E {r}_{0}}$ | Stress (σ_{c}) (MPa) |
| 23 | 0.85 | 40 | 47.1 | 4.7 | 0.569 |
| 24 | 0.85 | 50 | 58.8 | 5.9 | 0.584 |
| 25 | 0.85 | 60 | 70.6 | 7.1 | 0.596 |
| 26 | 0.85 | 70 | 82.4 | 8.2 | 0.605 |
| 27 | 0.95 | 40 | 42.1 | 4.2 | 0.627 |
| 28 | 0.95 | 50 | 52.6 | 5.3 | 0.644 |
| 29 | 0.95 | 60 | 63.2 | 6.3 | 0.658 |
| 30 | 0.95 | 70 | 73.7 | 7.4 | 0.669 |

### Comparative Examples

Oligomeric materials containing a di-adduct compound were previously described in U.S. Patent Application Publication No. 20150071595 ('595 application), the disclosure of which is hereby incorporated in its entirety by reference herein. In the '595 application, a series of twelve oligomeric materials prepared from H12MDI (4,4′-methylene bis(cyclohexyl isocyanate), PPG4000 (polypropylene glycol with Mₙ˜4000 g/mol) and HEA (2-hydroxyethyl acrylate) were described. Coating compositions containing the oligomeric materials and cured films formed from the coating compositions were also described. The molar ratio n (H12MDI):m (HEA):p (PPG4000) described in the '595 application, however, differed from the molar ratio n (H12MDI):m (HEA):p (PPG4000) described herein. This section discusses performance advantages that cured films made from coating compositions containing the present oligomeric materials exhibit relative to cured films made from coating compositions containing the oligomeric materials of the '595 application. Aspects of the '595 application relevant to the present discussion are presented below. Additional details are available in the '595 application. The twelve oligomeric materials of the '595 application will be referred to herein as comparative oligomeric materials and will be identified as Samples C1-C12.

The amounts and corresponding mole numbers of H12MDI, HEA and PPG4000 used to prepare the oligomeric materials of the comparative oligomeric materials are listed in Table 12.

TABLE 12
Reactants and Amounts for Comparative Oligomeric Materials 1-12

| | | | | H12MDI | HEA | PPG4000 |
|---|---|---|---|---|---|---|
| | | | | Mole | Mole | Mole |
| | H12MDI | HEA | PPG4000 | Number | Number | Number |
| Sample | (g) | (g) | (g) | (n) | (m) | (p) |
| C1 | 24.3 | 7.6 | 220.2 | 3.5 | 2.6 | 2 |
| C2 | 25.4 | 8.2 | 220.2 | 3.7 | 3.09 | 2 |
| C3 | 25.9 | 8.5 | 215.6 | 3.85 | 3.89 | 2 |
| C4 | 26.8 | 8.9 | 241.4 | 4 | 4.02 | 2 |
| C5 | 24.3 | 7.6 | 220.2 | 4 | 3 | 2 |
| C6 | 24.6 | 7.8 | 217.6 | 3.5 | 2.5 | 2 |
| C7 | 23.9 | 7.5 | 218.6 | 3.5 | 2.98 | 2 |
| C8 | 23.9 | 7.5 | 218.6 | 3.5 | 2.5 | 2 |
| C9 | 25.0 | 8.1 | 216.9 | 3.7 | 4 | 2 |
| C10 | 25.0 | 8.1 | 216.9 | 3.7 | 4 | 2 |
| C11 | 24.6 | 7.8 | 217.6 | 3.5 | 5 | 2 |
| C12 | 24.6 | 7.2 | 217.6 | 3.5 | 3.78 | 2 |

The procedure used to make the comparative oligomeric materials was similar to the procedure used to prepare oligomeric material Samples 1-6. The main difference between the procedures was that lower temperatures were used to form the comparative oligomeric materials. Instead of heating to 70° C.-75° C. for about 1-1½ hours after adding the PPG4000, the reactants used to form the comparative oligomeric materials were heated to 60° C.-64° C. for about 1-1½ hours. Samples C6, C8, and C9 were subjected to further heating at 60° C. for 24 hours. Similarly, after addition of supplemental HEA, the reaction mixture used to form the comparative oligomeric materials was heated to 60° C.-64° C. for about 1-1½ hours instead of to 70° C.-75° C. for about 1-1½ hours. Also, in the preparation of the comparative oligomeric materials, the flask was cooled to 56° C.-58° C. instead of to below 65° C. before adding the supplemental HEA. For Sample C5, an additional 1.25 g HEA was added after complete quenching of isocyanate groups was observed. Detection of isocyanate groups using FTIR and determination of the amount (wt %) of di-adduct compound in the comparative oligomeric materials was completed as described above for Samples 1-6. Table 13 shows the amount of supplemental HEA added during preparation of the comparative oligomeric materials and the amount of di-adduct in each of the comparative oligomeric materials.

TABLE 13
Supplemental HEA Additions and Di-adduct
Compound Content - Samples C1-C12

| | Supplemental | Di-adduct |
|---|---|---|
| Sample | HEA (g) | Compound (wt %) |
| C1 | 0.2 | 2.35 |
| C2 | 1.0 | 3.05 |
| C3 | 3.1 | 3.84 |
| C4 | 3.0 | 4.82 |
| C5 | 1.5 + 1.25 | 2.29 |
| C6 | 0 | 2.95 |
| C7 | 1.5 | 2.45 |
| C8 | 0 | 2.41 |
| C9 | 4.0 | 3.39 |
| C10 | 4.0 | 2.93 |
| C11 | 8.0 | 2.85 |
| C12 | 4.0 | 3.38 |

Coating compositions containing each of the comparative oligomeric materials were formulated and cured to form films. The procedures to cure films and the measurement techniques used to determine properties of the cured films are as described above for Samples 1-6. Table 14 lists the components in the coating composition. The description of the components in Table 14 corresponds to the descriptions presented above for Table 4. Pentaerythritol tetrakis(3-mercaptopropionate) (available from Aldrich) was used as the strength additive instead of tetrathiol. A separate composition was formulated and cured for each of the comparative oligomeric materials. Tables 15 and 16 list Young's modulus, tear strength, critical stress and the ratios G_{c}/E and G_{c}/Er₀ for each comparative sample. A value r₀=10 μm was used.

TABLE 14
Coating Composition for Comparative Film Samples

| Component | Amount |
|---|---|
| Comparative | 49.10 wt % |
| Oligomeric Material | |
| Sartomer SR504 | 45.66 wt % |
| V-CAP/RC | 1.96 wt % |
| TPO (Lucirin) | 1.47 wt % |
| 1035 (Irganox) | 0.98 wt % |
| 3-Acryloxypropyl | 0.79 wt % |
| trimethoxysilane | |
| Pentaerythritol | 0.03 wt % |
| tetrakis(3-mercapto | |
| propionate) | |

TABLE 15
Young's Modulus, Tear Strength, and Critical
Stress of Comparative Film Samples

| | Young's | Tear | | | Critical |
|---|---|---|---|---|---|
| Sample | Modulus (E) (MPa) | Strength (G_{c}) (J/m²) | $\frac{{G}_{c}}{E} ( μ m )$ | $\frac{{G}_{c}}{E {r}_{0}}$ | Stress (σ_{c}) (MPa) |
| C1 | 0.46 | 16.8 | 36.5 | 3.65 | 0.3 |
| C2 | 0.54 | 20.5 | 38 | 3.8 | 0.35 |
| C3 | 0.59 | 22.8 | 38.6 | 3.86 | 0.38 |
| C4 | 0.72 | 26.5 | 36.8 | 3.68 | 0.47 |
| C5 | 0.48 | 20 | 41.7 | 4.17 | 0.32 |
| C6 | 0.55 | 23.4 | 42.6 | 4.26 | 0.36 |

TABLE 16
Young's Modulus, Tear Strength, and Critical
Stress of Comparative Film Samples

| | Young's | Tear | | | Critical |
|---|---|---|---|---|---|
| Sample | Modulus (E) (MPa) | Strength (G_{c}) (J/m²) | $\frac{{G}_{c}}{E} ( μ m )$ | $\frac{{G}_{c}}{E {r}_{0}}$ | Stress (σ_{c}) (MPa) |
| C7 | 0.46 | 21 | 45.7 | 4.57 | 0.31 |
| C8 | 0.5 | 23.7 | 47.4 | 4.74 | 0.33 |
| C9 | 0.55 | 27 | 49.1 | 4.91 | 0.37 |
| C10 | 0.51 | 26.1 | 51.2 | 5.12 | 0.34 |
| C11 | 0.52 | 21.8 | 41.9 | 4.19 | 0.34 |
| C12 | 0.46 | 21 | 45.7 | 4.57 | 0.31 |

The results indicate that for comparable Young's modulus, coatings that include oligomeric materials in accordance with the present disclosure exhibit higher tear strength, higher ratios G_{c}/E and G_{c}/Er₀, and higher critical stress than comparative coatings. Coatings prepared from compositions including the present oligomeric materials are thus more robust, stable, and resistant to draw-induced defects than the comparative coatings.

Stripping Performance.

Additional experiments were performed to test the stripping performance of coatings made from coating compositions that included Sample 4 and comparative Sample C10 as oligomers. The coating composition using Sample 4 as the oligomer corresponded to the coating composition listed in Table 4 above. The coating composition using comparative Sample C10 as the oligomer corresponded to the coating composition listed in Table 14 above. In both coating compositions tested for stripping performance, the ethoxylated(4)nonylphenol acrylate component was obtained as Product No. M164 from Miwon instead of Product No. SR504 from Sartomer. The coating compositions were otherwise the same as those listed in Tables 4 and 14 for Sample 4 and comparative Sample C10, respectively.

Stripping performance relates to the ability to strip a coating from an optical fiber. Stripping is a common operation that is used in splicing fibers and attaching connectors to optical fibers. It is desirable for the fiber coating to be removed cleanly from the optical fiber during stripping without leaving debris on the surface of the fiber.

Four experiments were completed to test stripping performance of the two coating compositions: (1) a tensile toughness test, (2) a peel adhesion test, (3) a fiber pullout test, and (4) a static damage resistance test. Tensile toughness and peel adhesion were measured on film samples made from the two coating compositions. Fiber pullout and static damage resistance were measured on separate optical fibers with primary coatings formed from each of the two coating compositions. The optical fibers further included a secondary coating.

Tensile Toughness Test.

Tensile toughness was measured on films formed by curing the coating compositions. Wet films were cast on silicone release paper with the aid of a draw-down box having a gap thickness of about 0.005″. Films were cured with a UV dose of 1.2 J/cm² (measured over a wavelength range of 225-424 nm by a Light Bug model IL490 from International Light) by a Fusion Systems UV curing apparatus with a 600 W/in D-bulb (50% power and approximately 12 ft/min belt speed) to yield coatings in film form from the coating compositions. Cured film thickness was between about 0.0030″ and 0.0035″. The films were allowed to age (23° C., 50% relative humidity) for at least 16 hours prior to testing. Film samples were cut to dimensions of 12.5 cm×13 mm using a cutting template and a scalpel. Tensile toughness was measured at room temperature on the film samples using a MTS Sintech tensile tester. Tensile toughness is defined as the integrated area under the stress-strain curve. Films were tested at an elongation rate of 2.5 cm/min with the initial gauge length of 5.1 cm. The Young's modulus and tear strength were also measured for the films. The results are summarized in Table 17. In Table 17, the column labelled “Sample C10” refers to a film formed from the coating composition that included comparative Sample C10 as the oligomer and the column labelled “Sample 4” refers to a film formed from the coating composition that included Sample 4 as the oligomer. The results indicate that coatings made using Sample 4 as the oligomer have higher tensile toughness and higher tear strength than coatings made using comparative Sample C10 while maintaining a low Young's modulus.

TABLE 17
Tensile Properties

| | Sample C10 | Sample 4 |
|---|---|---|
| Young's Modulus (MPa) | 0.70 | 0.70 |
| Tensile Toughness (kJ/m³) | 407 | 838 |
| Tear Strength (J/m²) | 29 | 43 |

The tensile toughness of the present coatings, when configured as a cured film having a thickness between 0.0030″ and 0.0035″, is greater than 500 kJ/m³, or greater than 600 kJ/m³, or greater than 700 kJ/m³, or greater than 800 kJ/m³, or in the range from 500 kJ/m³ to 1200 kJ/m³, or in the range from 600 kJ/m³ to 1100 kJ/m³, or in the range from 700 kJ/m³ to 1000 kJ/m³.

Peel Adhesion Test.

Adhesion of coatings formed from the coating compositions to glass was measured by a 90 degree peel test, based on the ASTM D413 standard. Glass plates were pre-heated to the test temperatures of 20° C., 60° C., 90° C., and 120° C. respectively. The coating compositions were casted on the pre-heated glass plates with the aid of a draw-down box having a gap thickness of about 0.005″ and immediately cured under UV irradiation at the dose of 1.2 J/cm². The thickness of the cured films was 75-90 μm. The peel tests were performed on a MTS Sintech tensile tester. The glass plate was secured horizontally, and a 1 inch width of coating was then peeled at an angle of 90 degrees from the glass plate at a rate of 2.0 inch/min.

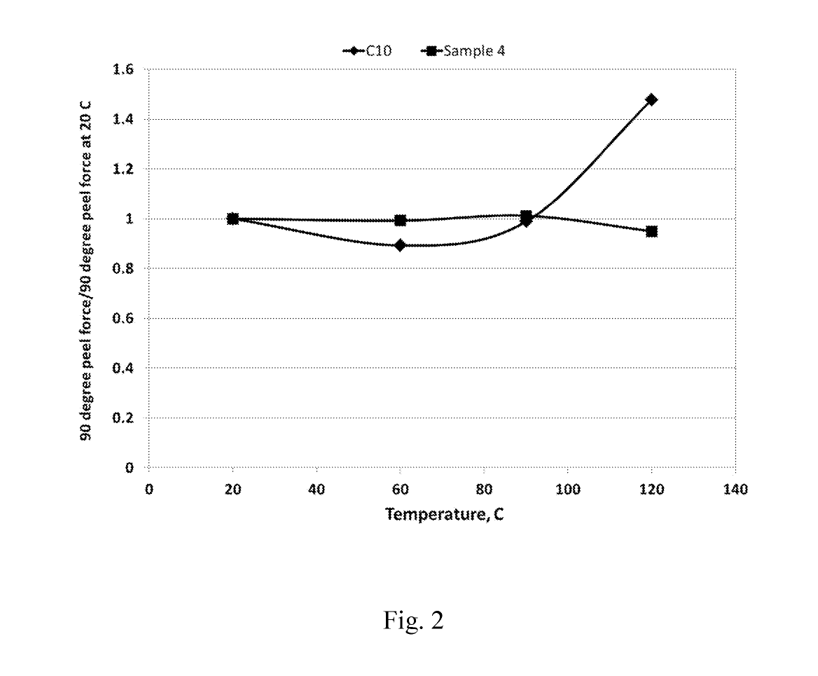

The results of the peel adhesion test are shown in FIG. 2 for coatings made from coating compositions using comparative Sample C10 and Sample 4 as the oligomer. The plot presented in FIG. 2 shows the 90 degree peel force of the coatings at various temperature of the glass plate relative to the 90 degree peel force of the coating at a temperature of 20° C. of the glass plate. The results indicate that the coating made using Sample 4 as the oligomer has a peel force that is more nearly constant with temperature than the coating made using comparative Sample C10 as the oligomer. Based on the peel test performance, it is expected that coatings made using Sample 4 as the oligomer will exhibit cleaner stripping characteristics than coating made using comparative Sample C10 as the oligomer.

The coatings disclosed herein, when measured according to the ASTM D413 standard, have a 90 degree peel force at 120° C. that is less than 40% larger than the 90 degree peel force at 20° C., or a 90 degree peel force at 120° C. that is less than 30% larger than the 90 degree peel force at 20° C., or a 90 degree peel force at 120° C. that is less than 20% larger than the 90 degree peel force at 20° C., or a 90 degree peel force at 120° C. that is less than 10% larger than the 90 degree peel force at 20° C., or a 90 degree peel force at 120° C. that is less than the 90 degree peel force at 20° C.

Fiber Pullout Test.

The fiber pullout tests were based on the procedures described in FOTP-105 and the recommended standard EIA/TIA-455. Separate glass fibers (diameter 125 μm) were coated with the coating compositions that included Sample 4 and comparative Sample C10 as oligomers. The coating compositions were cured with mercury lamps to form primary coatings on an optical fiber. The thickness of the primary coating was 32.5 μm. The coated fibers also included a secondary coating with a thickness of 26 μm and a Young's modulus of 1600 MPa. The secondary coatings were formed by applying a secondary coating composition to the (cured) primary coating and curing the secondary coating composition with mercury lamps to form a secondary coating.

The fiber pullout test measured the peak force needed to pull a 1 cm length of glass fiber out of each of the coatings. To perform the test, the coating at each end of the coated fiber was fixed (glued) to separate support surfaces made with a 1 square inch tab of heavy stock paper. The coating at each end was circumferentially cut at a distance of 1 cm from the support surface and nicked at the interface with the support surface. The glass fiber was then pulled out of the coating by pulling the two tabs apart and the peak force was determined. The peak pulling force needed to remove the glass fiber from the coating is a measure of the strength of adhesion of the coating to the glass fiber.

Several fiber test specimens with coatings made from coating compositions containing each of the two oligomers were measured. In particular, ten five-inch long fibers were cut for each test. One of the ends of each test specimens was then glued to a separate paper tab with Krazy Wood Glue®. This was done by applying approximately a 1.5 cm long thin layer of glue from the middle of the edge of the paper tab through the center of the paper tab and laying the end of the fiber lengthwise along the glue. The other coated end of the test specimen was glued to a second tab by the same process. The test specimens were further conditioned in a 50% RH (relative humidity) chamber at 23° C. overnight. Each test specimen was then cut at 1 cm (gauge length) from the glued edge. The cut extended through the glue and the fiber down to the tab. The coating was nicked with a razor blade at the cross-section of the fiber and the tab. Each specimen was loaded into the grippers such that the top gripper clamped the tab furthest from the cut at the 1 cm gauge length position and the bottom gripper clamped the tab closest to the cut at the 1 cm gauge length position on the designated tab. The grippers were pulled apart and the force needed to separate the glass fiber from the coating was determined. More particularly, a MTS tensile tester equipped with Testworks 4 software, a 5 lb load cell, and pneumatic grippers were used for the fiber pull out test. The grippers were pulled apart at a speed of 5 mm/min. The measurements were completed at room temperature.

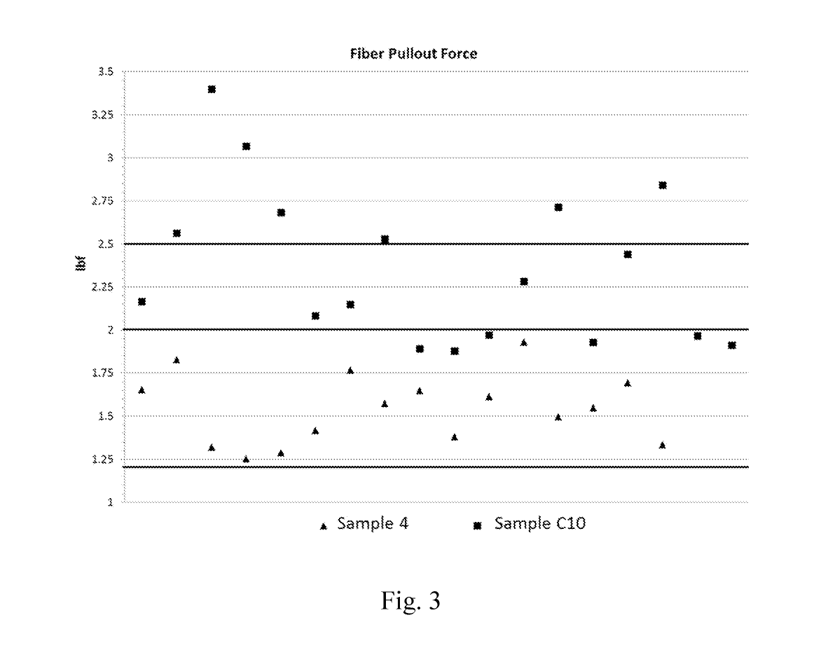

The results of the fiber pullout test are shown in FIG. 3. The pullout force for multiple test specimens of fibers coated with coating compositions that included Sample 4 as the oligomer (▴) and comparative Sample C10 as the oligomer (▪). Fiber pullout force has been shown to be indicative of the fiber strip cleanliness performance. When the pullout force is between 1.2 to 2.0 lbf, excellent strip cleanliness with little or no residue can be expected. When the pullout force is between 2.0 to 2.5 lbf, some debris and coating residues are usually observed after the coating has been stripped. When the pullout force is over 2.5 lbf, excessive residue and debris are often observed after the coating has been stripped. Such excessive residue and debris after stripping will lead to the performance issue of fiber splicing failure. The fiber pullout results indicate that the pullout force of fibers coated with the composition including Sample 4 as the oligomer is consistently within 1.2 to 2.0 lbf, while the pullout force of fibers coated with the composition including comparative Sample C10 as the oligomer varies between 1.9 to 3.4 lbf.

The pullout force of the present coatings, when configured as a primary coating with a thickness of 32.5 μm on a glass fiber having a diameter of 125 μm and surrounded by a secondary coating with a thickness of 26 μm and Young's modulus of 1600 MPa, is less than 1.8 lbf, or less than 1.6 lbf, or less than 1.5 lbf, or less than 1.4 lbf, or less than 1.3 lbf, or in the range from 1.2 lbf to 1.8 lbf, or in the range from 1.3 lbf to 1.7 lbf, or in the range from 1.4 lbf to 1.6 lbf.

Static Damage Resistance Test.

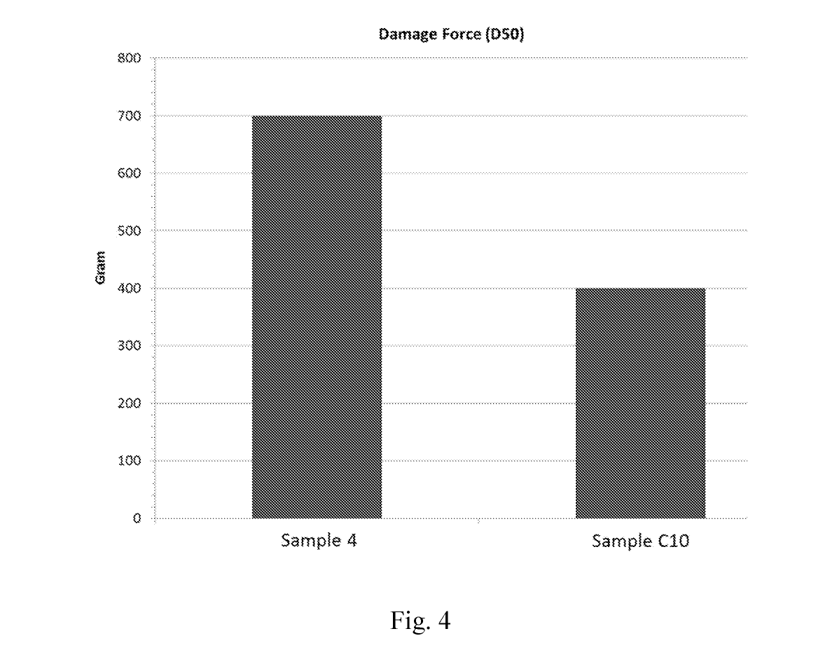

The static damage resistance test was performed using an apparatus similar to U.S. Pat. No. 5,908,484, U.S. Pat. No. 6,243,523, and U.S. Pat. No. 6,289,158, the disclosures of which are incorporated by reference herein. The static damage resistance was determined according to the method reported by Tabaddor et al. in Proc. 47th IWCS, p. 725 (1998). In this test, a coated fiber was laid horizontally on a glass slide at room temperature and placed under a tension of 5 g. The diameter of the glass portion of the fiber was 125 μm. The thickness of the coating was 32.5 μm. A ¼-inch diameter steel rod was aligned perpendicularly above the coated fiber. The rod was loaded with a desired test weight, lowered to contact the coated fiber, held in place for 5 seconds, and released. For each loaded weight, 30 sites (spaced apart by ⅛ inch) along the coated fiber were tested. Observations of damage were recorded using real time video, and final inspections were made under a compound microscope after testing was completed. The force for 50% damage (D50), corresponding to the load causing damage to 50% of the test sites, was calculated by plotting the probability of damage (fraction of damaged test sites) versus load in grams. D50 values (reported in units of grams) for fibers coated with compositions including Sample 4 and comparative Sample C10 are shown in FIG. 4. A much higher load was required to damage the coating made from the composition using Sample 4 as an oligomer than the coating made from the composition using comparative Sample C10 as the oligomer.

The force for 50% damage (D50) of the present coatings, when configured as a coating with a thickness of 32.5 μm on a glass fiber having a diameter of 125 μm and placed under a tension of 5 g, is greater than 400 g, or greater than 500 g, or greater than 600 g, or greater than 650 g, or in the range from 425 g to 800 g, or in the range from 450 g to 750 g, or in the range from 475 g to 700 g, or in the range from 500 g to 675 g.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A composition comprising:
a diisocyanate compound;
a hydroxy (meth)acrylate compound; and
a polyol compound, said polyol compound having unsaturation less than 0.1 meq/g;
wherein said diisocyanate compound, said hydroxy (meth)acrylate compound and said polyol compound are present in the molar ratio n:m:p, respectively, where n is in the range from 3.0 to 5.0, m is in the range from 1.50n-3 to 2.50n-5, and p is 2.

2. The composition of claim 1, wherein said diisocyanate compound comprises a compound having the formula: 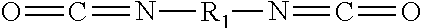
wherein the group R₁ comprises an alkylene group.

3. The composition of claim 2, wherein said group R₁ comprises a 4,4′-methylenebis(cyclohexyl) group.

4. The composition of claim 1, wherein said polyol compound comprises a compound having the formula: 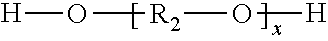
wherein the group R₂ comprises an alkylene group and x is between 40 and 100.

5. The composition of claim 1, wherein n is in the range from 3.4 to 4.6 and m is in the range from 1.60n-3 to 2.40n-5.

6. The composition of claim 1, wherein said polyol is polypropylene glycol having a number average molecular weight in the range from 3000 g/mol to 9000 g/mol.

7. The reaction product of the composition of claim 1, wherein the reaction product comprises:
an oligomeric material, said oligomeric material comprising:
a polyether urethane acrylate compound having the molecular formula: 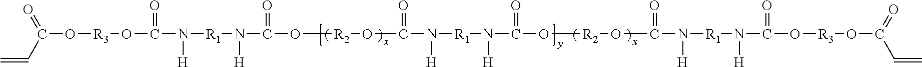
and a di-adduct compound having the molecular formula: 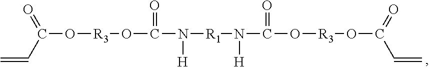
wherein
R₁, R₂ and R₃ are independently selected from linear alkylene groups, branched alkylene groups, or cyclic alkylene groups;
y is 1, 2, 3, or 4;
x is between 40 and 100;
said di-adduct compound is present in an amount of at least 1.0 wt %.

8. A fiber coating composition comprising:
one or more monomers with a radiation-curable group;
the reaction product of a composition comprising:
a diisocyanate compound;
a hydroxy (meth)acrylate compound; and
a polyol compound, said polyol having unsaturation less than 0.1 meq/g;
wherein said diisocyanate compound, said hydroxy (meth) acrylate compound and said polyol compound are present in the molar ratio n:m:p, respectively, where n is in the range from 3.0 to 5.0, m is in the range from 1.50n-3 to 2.50n-5, and p is 2;
a mercapto-functional silane compound;
and a photoinitiator.

9. The fiber coating composition of claim 8, wherein said reaction product comprises:
a polyether urethane acrylate compound having the molecular formula: 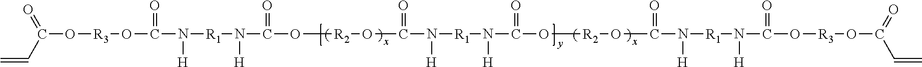
and a di-adduct compound having the molecular formula: 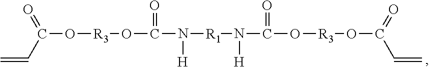
wherein
R₁, R₂ and R₃ are independently selected from linear alkyl groups, branched alkyl groups, or cyclic alkyl groups;
y is 1, 2, 3, or 4;
x is between 40 and 100; and
said di-adduct compound is present in an amount of at least 2.25 wt %;

10. The fiber coating composition of claim 8, wherein said mercapto-functional silane compound has a concentration greater than 0.5 wt %.

11. The fiber coating composition of claim 8, wherein said oligomeric material has a concentration between 25 wt % and 65 wt %.

12. The fiber coating composition of claim 8, wherein said optical fiber coating composition has a modulus crossover time at 20° C. of less than 0.5 second when cured to a film of thickness 50 μm with a 395 nm LED source having an intensity of 100 mW/cm² while applying an oscillatory shear strain at 20 Hz frequency.

13. The cured product of the fiber coating composition of claim 8, wherein said reaction product comprises:
a polyether urethane acrylate compound having the molecular formula: 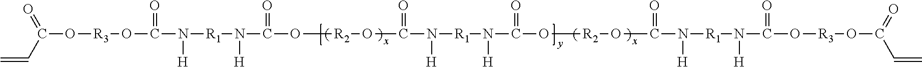
and a di-adduct compound having the molecular formula: 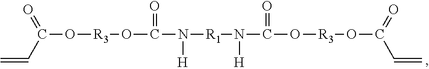
wherein
R₁, R₂ and R₃ are independently selected from linear alkyl groups, branched alkyl groups, or cyclic alkyl groups;
y is 1, 2, 3, or 4;
x is between 40 and 100; and
said di-adduct compound is present in an amount of at least 1.0 wt %;
wherein said cured product has a tear strength G_{c} of at least 35 J/m² and a Young's modulus E less than 1.0 MPa.

14. The cured product of the fiber coating composition of claim 8, wherein said cured product has a critical stress σ_{c}, for a cavity size r₀=10 μm, of at least 0.40 MPa.

15. The cured product of the fiber coating composition of claim 8, wherein said cured product has a ratio G_{c}/E of tear strength G_{c} to Young's modulus E of at least 50 μm.

16. The cured product of the fiber coating composition of claim 8, wherein said cured product has a Young's modulus E less than 1.0 MPa, a tear strength G_{c} of at least 35 J/m², and a critical stress σ_{c}, for a cavity size r₀=10 μm, of at least 0.40 MPa.

17. The cured product of the fiber coating composition of claim 8, wherein said cured product, when configured as a film having a thickness between 0.0030″ and 0.0035″, has a tensile toughness greater than 500 kJ/m³.

18. The cured product of the fiber coating composition of claim 8, wherein said cured product, when measured according to the ASTM D413 standard, has a 90 degree peel force at 120° C. that is less than 20% larger than the 90 degree peel force at 20° C.

19. The cured product of the fiber coating composition of claim 8, wherein said cured product, when a configured as a coating with a thickness of 32.5 μm on a glass fiber, has a pullout force less than 1.8 lbf.

20. The cured product of the fiber coating composition of claim 8, wherein said cured product, when a configured as a coating with a thickness of 32.5 μm on a glass fiber and placed under a tension of 5 g, has a force for 50% damage (D50) greater than 500 g.

21. The cured product of the fiber coating composition of claim 8, wherein said cured product has maximum complex modulus Gₘₐₓ* less than 0.4 MPa when cured to a film of thickness 50 μm with a 395 nm LED source having an intensity of 100 mW/cm² while applying an oscillatory shear strain at 20 Hz frequency.

22. The cured product of the fiber coating composition of claim 8, wherein said cured product has % Reacted Acrylate Unsaturation (% RAU) of greater than 80%.

23. A method of coating an optical fiber comprising:
applying a coating composition to an optical fiber, said optical fiber moving at a draw speed greater than 35 m/s, said coating composition comprising:
an oligomeric material, said oligomeric material comprising a reaction product of:
a diisocyanate compound lacking aromatic groups;
a hydroxy (meth)acrylate compound; and
a polyol compound comprising polypropylene glycol having unsaturation less than 0.1 meq/g; and
a mercapto-functional silane compound;
wherein said diisocyanate compound, said hydroxy (meth)acrylate compound and said polyol compound are present in the molar ratio n:m:p, respectively, and wherein 3<n<5, m is in the range from 1.50n-3 to 2.50n-5, and p is 2; and
curing said coating composition with an LED source having a operating wavelength between 300 nm and 400 nm, said curing forming a cured product having % Reacted Acrylate Unsaturation (% RAU) greater than 80%.
